(19) United States
(12) Patent Application Publication
(10) Pub. No.: US 2021/0089966 A1
(43) Pub. Date: Mar. 25, 2021

(54) UPSIDE-DOWN REINFORCEMENT LEARNING

(71) Applicant: Nnaisense SA, Lugano (CH)

(72) Inventors: Juergen Schmidhuber, Lugano (CH); Rupesh Kumar Srivastava, Santa Clara, CA (US)

(21) Appl. No.: 17/029,433

(22) Filed: Sep. 23, 2020

Related U.S. Application Data
(60) Provisional application No. 62/904,796, filed on Sep. 24, 2019.

(51) Int. Cl. G06N 20/00

(52) U.S. Cl. CPC G06N 20/00

(57) ABSTRACT

A method, referred to herein as upside down reinforcement learning (UDRL), includes: initializing a set of parameters for a computer-based learning model; providing a command input into the computer-based learning model as part of a trial, wherein the command input calls for producing a specified reward within a specified amount of time in an environment external to the computer-based learning model; producing an output with the computer-based learning model based on the command input; and utilizing the output to cause an action in the environment external to the computer-based learning model. Typically, during training, the command inputs (e.g., “get so much desired reward within so much time,” or more complex command inputs) are retrospectively adjusted to match what was really observed.

### CROSS-REFERENCE TO RELATED APPLICATION(S)

This application claims the benefit of priority to U.S. Provisional Patent Application No. 62/904,796, entitled Reinforcement Learning Upside Down: Don't Predict Rewards—Just Map Them to Actions, which was filed on Sep. 24, 2019. The disclosure of the prior application is incorporated by reference herein in its entirety.

### FIELD OF THE INVENTION

This disclosure relates to the field of artificial intelligence and, more particularly, relates to a method of learning/training in an artificial learning model environment.

### BACKGROUND

Traditional reinforcement learning (RL) is based on the notion of learning how to predict rewards based on previous actions and observations and transforming those predicted rewards into subsequent actions. Traditional RL often involves two networks, each of which may be a recurrent neural network (“RNN”). These networks may include a controller network, the network being trained to control, and a predictor network that helps to train the controller network. The implicit goal of most traditional RL is to teach the controller network how to optimize the task at hand.

Improvements in training techniques for learning models, such as recurrent neural networks, are needed.

### SUMMARY OF THE INVENTION

In one aspect, a method, referred to herein as upside down reinforcement learning (“UDRL,” or referred to herein with an upside down “RL”), includes: initializing a set of parameters for a computer-based learning model; providing a command input into the computer-based learning model as part of a trial, wherein the command input calls for producing a specified reward within a specified amount of time in an environment external to the computer-based learning model; producing an output with the computer-based learning model based on the command input; and utilizing the output to cause an action in the environment external to the computer-based learning model.

In a typical implementation, the method includes receiving feedback data from one or more feedback sensors in the external environment after the action. The feedback data can include, among other things, data that represents an actual reward produced in the external environment by the action.

The output produced by the computer-based learning model depends, at least in part, on the set of parameters for the computer-based learning model (and also on the command input to the computer-based learning model).

In a typical implementation, the method includes storing a copy of the set of parameters in computer-based memory. The set of parameters in the copy may be adjusted by using, for example, supervised learning techniques based on observed prior command inputs to the computer-based learning model and observed feedback data. The adjustments produce an adjusted set of parameters. Periodically, the set parameters used by the computer-based learning model to produce the outputs may be replaced with a then-current version of the adjusted set of parameters.

In some implementations, the method includes initializing a value in timer for the trial prior to producing an initial output in the machine-learning model, and incrementing the value in the timer to a current value if the trial is not complete after causing the action in the external environment. Moreover, in some implementations, the method includes updating a time associated with adjusting the set of parameters in the copy to match the current value.

The computer-based learning model can be any one of a wide variety of learning models. In one exemplary implementation, the learning model is an artificial neural network, such as a recurrent neural network.

The specified reward in the specified amount of time in the command input can be any reward and any amount of time; it need not represent an optimization of reward and time.

In some implementations, one or more of the following advantages are present.

For example, efficient, robust and effective training may be done in any one of a variety of learning models/machines including, for example, recurrent neural networks, decision trees, and support vector machines.

In some implementations, UDRL provides a method to compactly encode knowledge about any set of past behaviors in a new way. It works fundamentally in concert with high-capacity function approximation to exploit regularities in the environment. Instead of making predictions about the long-term future (as value functions typically do), which are rather difficult and conditional on the policy, it learns to produce immediate actions conditioned on desired future outcomes. It opens-up the exciting possibility of easily importing a large variety of techniques developed for supervised learning with highly complex data into RL.

Many RL algorithms use discount factors that distort true returns. They are also very sensitive to the frequency of taking actions, limiting their applicability to robot control. In contrast, UDRL explicitly takes into account observed rewards and time horizons in a precise and natural way, does not assume infinite horizons, and does not suffer from distortions of the basic RL problem. Note that other algorithms such as evolutionary RL may avoid these sorts of issues in otherways.

In certain implementations, the systems and techniques disclosed herein fall in the broad category of RL algorithms for autonomously learning to interact with a digital or physical environment to achieve certain goals. Potential applications of such algorithms include industrial process control, robotics and recommendation systems. Some ofthe systems and techniques disclosed herein may help bridge the frameworks of supervised and reinforcement learning, it may, in some instances make solving RL problems easier and more scalable. As such, it has the potential to increase both some positive impacts traditionally associated with RL research. An example of this potential positive impact is industrial process control to reduce waste and/or energy usage (industrial combustion is a larger contributor to global greenhouse gas emissions than cars).

In typical implementations, the systems and techniques disclosed herein transform reinforcement learning (RL) into a form of supervised learning (SL) by turning traditional RL on its head, calling this Upside Down RL (UDRL). Standard RL predicts rewards, while UDRL instead uses rewards as task-defining inputs, together with representations of time horizons and other computable functions of historic and desired future data. UDRL learns to interpret these input observations as commands, mapping them to actions (or action probabilities) through SL on past (possibly accidental) experience. UDRL generalizes to achieve high rewards or other goals, through input commands such as: get lots of reward within at most so much time! First experiments with UDRL shows that even a pilot version of UDRL can outperform traditional baseline algorithms on certain challenging RL problems.

Moreover, in some implementations, the systems and techniques disclosed herein conceptually simplify an approach for teaching a robot to imitate humans. First videotape humans imitating the robot's current behaviors, then let the robot learn through SL to map the videos (as input commands) to these behaviors, then let it generalize and imitate videos of humans executing previously unknown behavior. This Imitate-Imitator concept may actually explain why biological evolution has resulted in parents who imitate the babbling of their babies.

Other features and advantages will be apparent from the description and drawings, and from the claims.

### BRIEF DESCRIPTION OF THE DRAWINGS

FIG. 1 is a schematic representation of a computer system.

FIG. 2 is a schematic representation of an exemplary recurrent neural network (RNN) that may be implemented in the computer system of FIG. 1.

FIG. 3 is a flowchart representing an exemplary implementation of an upside-down reinforcement learning training process, which may be applied, for example, to the RNN of FIG. 2.

FIG. 4 is a state diagram for a system or machine in an external environment from to the computer system of FIG. 1 and configured to be controlled by the computer system of FIG. 1.

FIG. 5 is a table that shows supervised learning labels (under the “action” header) that might be generated and applied to each corresponding state, associated reward (“desired return”), and time horizon (“desired horizon”) by the computer system of FIG. 1 based on the scenario represented in the diagram of FIG. 4.

FIG. 6 includes plots of mean return vs. environmental steps for four different video games where control is based on different learning machine training algorithms.

FIGS. 7A-7C includes plots of data relevant to different video games controlled based on different learning machine training algorithms.

FIGS. 8A-8D are screenshots from different video games.

FIG. 9 is a plot of data relevant to the SwimmerSparse-v2 video game with control based on different training algorithms.

FIGS. 10A-10F are plots of data relevant to control of different video games.

Like reference characters refer to like elements.

### DETAILED DESCRIPTION

This disclosure relates to a form of training learning models, such as recurrent neural networks (RNN). The training techniques are referred to herein as upside-down reinforcement learning (UDRL).

### Part I—UDRL

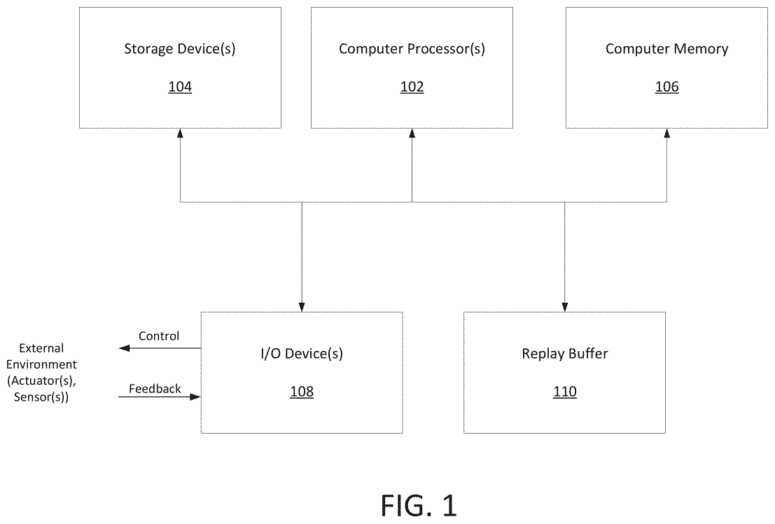

FIG. 1 is a schematic representation of a computer system 100 specially programmed and configured to host an artificial intelligence (AI) agent, which may be in the form of a recurrent neural network (RNN). In a typical implementation, the computer system 100 is configured to interact with an environment outside the computer system 100 to influence or control that environment and to receive feedback from that environment. The RNN can be trained in accordance with one or more of the techniques disclosed herein that referred to as upside-down reinforcement learning (UDRL). These techniques have been shown to be highly effective in training AI agents.

Traditional reinforcement learning (RL) is based on the notion of learning how to predict rewards based on previous actions and observations and transforming those predicted rewards into subsequent actions. Traditional RL often involves two networks, each of which may be a recurrent neural network (“RNN”). These networks may include a controller network, the network being trained to control, and a predictor network that helps to train the controller network. The implicit goal of most traditional RL is to teach the controller network how to optimize the task at hand. UDRL is radically different.

First, UDRL typically involves the training of only one single network (e.g., only one RNN). This is contrary to most RL, which, as discussed above, typically involves training a controller network and a separate predictor network.

Second, unlike RL, UDRL does not typically involve predicting rewards at all. Instead, in UDRL, rewards, along with time horizons for the rewards, are provided as inputs (or input commands) to the one single RNN being trained. An exemplary form of this kind of input command might be “get a reward of X within a time of Y,” where X can be virtually any specified value (positive or negative) that has meaning within the context of the external environment and Y can be virtually any positive specified value (e.g., from zero to some maximum value) and measure of time. A few examples of this kind of input command are “get a reward of 10 in 15 time steps” or “get a reward of −5 in 3 seconds” or “get a reward of more than 7 within the next 15 time steps.” The aim with these types of input commands in UDRL is for the network to learn how to produce many very specific, different outcomes (reward/time horizon combinations) for a given environment. Unlike traditional RL, the aim of UDRL typically is not to simply learn how to optimize a particular process, although finding an optimum outcome may, in some instances, be part of, or result from, the overall training process.

By interacting with an environment outside the computer system 100 the computer system 100 learns (e.g., through gradient descent) to map self-generated input commands of a particular style (e.g., specific reward plus time horizon) to corresponding action probabilities. The specific reward in this self-generated input command is not simply a call to produce an optimum output; instead, the specific reward is for the specific reward that already has been produced and observed based on a set of known actions. The knowledge, or data set, that is gained from these self-generated input commands enables the computer system 100 to extrapolate to solve new problems such as “get even more reward within even less time” or “get more reward than you have ever gotten in Y amount of time.”

Remarkably, the inventors have discovered that a relatively simple pilot version of UDRL already has outperformed certain RL methods on very challenging problems.

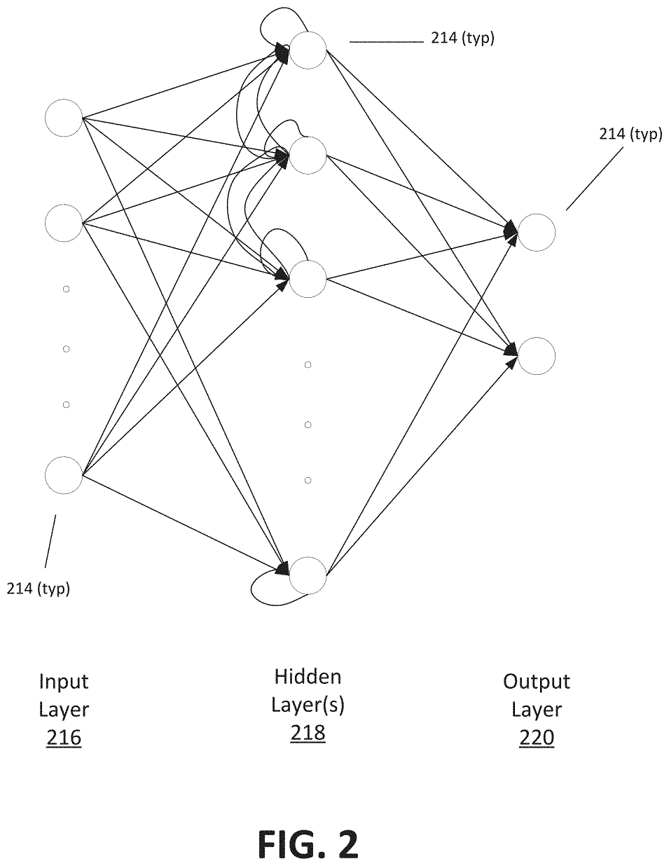

The computer system 100 of FIG. 1 has a computer-based processor 102, a computer-based storage device 104, and a computer-based memory 106. The computer-based memory 106 hosts an operating system and software that, when executed by the processor 102, causes the processor 102 to perform, support and/or facilitate functionalities disclosed herein that are attributable to the processor 102 and/or to the overall computer system 100. More specifically, in a typical implementation, the computer-based memory 106 stores instructions that, when executed by the processor 102, causes the processor 102 to perform the functionalities associated with the RNN (see, e.g., FIG. 2) that are disclosed herein as well as any related and/or supporting functionalities. The computer system 100 has one or more input/output (I/O) devices 108 (e.g., to interact with and receive feedback from the external environment) and a replay buffer 110. The replay buffer 110 is a computer-based memory buffer that is configured to hold packets of data that is relevant to the external environment with which the computer system 100 is interacting (e.g., controlling/influencing and/or receiving feedback from). In a typical implementation, the replay buffer 110 stores data regarding previous command/control signals (to the external environment), observed results (rewards and associated time horizons), as well as other observed feedback from the external environment. This data typically is stored so that a particular command/control signal is associated with the results and other feedback, if any, produced by the command/control signal. This data trains, or at least helps train, the RNN.

In some implementations, the system 100 of FIG. 1 may include a timer, which may be implemented by the processor 102 executing software in computer memory 106.

FIG. 2 is a schematic representation of an exemplary RNN 200 that may be implemented in the computer system 100 in FIG. 1. More specifically, for example, RNN 200 may be implemented by the processor 102 in computer system 100 executing software stored in memory 106. In a typical implementation, the RNN 200 is configured to interact, via the one or more I/O devices of computer system 100, with the external environment.

The RNN 200 has a network of nodes 214 organized into an input layer 216, one or more hidden layers 218, and an output layer 220. Each node 214 in the input layer 216 and the hidden layer(s) 218 is connected, via a directed (or one-way) connection, to every node in the next successive layer. Each node has a time-varying real-valued activation. Each connection has a modifiable real-valued weight. The nodes 214 in the input layer 216 are configured to receive commands inputs (representing and other data representing the environment outside the computer system 100. The nodes 214 in the output layer 220 yield results/outputs that correspond to or specify actions to be taken in the environment outside the computer system 100. The nodes 214 in the hidden layer(s) 218 modify the data en route from the nodes 214 in the input layer 216 to the nodes in the output layer 220. The RNN 200 has recurrent connections (e.g., among units in the hidden layer), including self-connections, as well.

UDRL can be utilized to train the RNN 200 of FIG. 2 within the context of system 100 in FIG. 1.

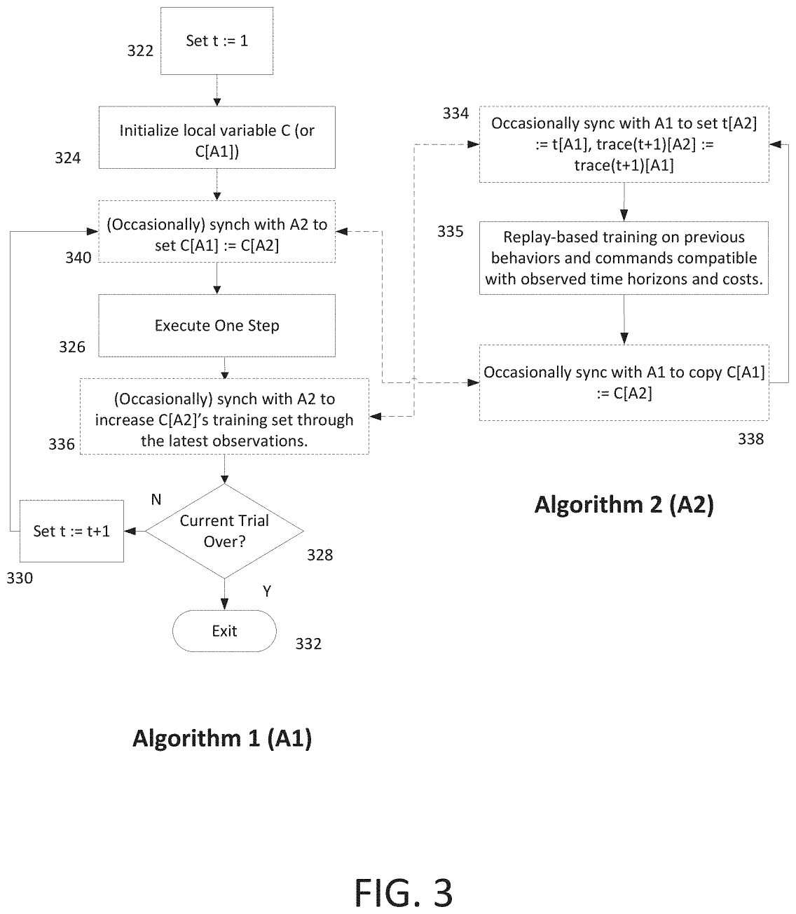

FIG. 3 is a flowchart representing an exemplary implementation of a UDRL training process, which may be applied, for example, to the RNN of FIG. 2 within the context of system 100 of FIG. 1.

The UDRL training process represented in the flowchart has two separate algorithms (Algorithm A1, and Algorithm A2). In a typical implementation, these algorithms would occur in parallel with one another. Moreover, although the two algorithms do occasionally synchronize with one another, as indicated in the illustrated flowchart, the timing of the various steps in each algorithm does not depend necessarily on the timing of steps in the other algorithm. Indeed, each algorithm typically proceeds in a stepwise fashion according to timing that may be independent from the other algorithm.

The flowchart represented in FIG. 3 shows the steps that would occur during one trial or multiple trials.

In broad terms, a trial may be considered to be a single attempt by the computer system 100 to perform some task or combination of related tasks (e.g., toward one particular goal). A trial can be defined by a discrete period of time (e.g., 10 seconds, 20 arbitrary time steps, an entire lifetime of a computer or computer system, etc.), by a particular activity or combination of activities (e.g., an attempt to perform a particular task or solve some particular problem or series of problems), or by an attempt to produce a specified amount of reward (e.g., 10, 20, −5, etc.) perhaps within a specified time period (e.g., 2 seconds, 10 seconds, etc.), as specified within a command input to the RNN. In instances where multiple trials occur sequentially, sequential trials may be identical or different in duration.

During a trial, the computer system 100 (agent) may perform one or more steps. Each step amounts to an interaction with the system's external environment and may result in some action happening in that environment and feedback data provided from the environment back into the computer system 100. In a typical implementation, the feedback data comes from one or more feedback sensors in the environment. Each feedback sensor can be connected, either directly or indirectly (e.g., by one or more wired or wireless connections) to the computer system 100 (e.g., through one or more of its I/O devices). Each feedback sensor is configured to provide data, in the form of a feedback signal, to the computer system 100 on a one time, periodic, occasional, or constant basis. The feedback data typically represents and is recognized by the computer system 100 (and the RNN) as representing, a current quantification of a corresponding characteristic of the external environment—this can include rewards, timing data and/or other feedback data. In a typical implementation, the characteristic sensed by each feedback sensor and represented by each piece of feedback data provided into the computer system 100 may change over time (e.g., in response to actions produced by the computer system 100 taking one or more steps and/or other stimuli in or on the environment).

In a typical implementation, certain of the feedback data provided back to the computer system 100 represents a reward (either positive or negative). In other words, in some instances, certain feedback data provided back to the computer system 100 may indicate that one or more actions caused by the computer system 100 have produced or achieved a goal or made measurable progress toward producing or achieving the goal. This sort of feedback data may be considered a positive reward. In some instances, certain feedback data provided back to the computer system 100 may indicate that one or more actions caused by the computer system 100 either failed to produce or achieve the goal or made measurable progress away from producing or achieving the goal. This sort of feedback data may be considered a negative reward.

Consider, for example, a scenario in which the computer system 100 is connected (via one or more I/O devices) to a video game and configured to provide instructions (in the form of one or more data signals) to the video game to control game play and to receive feedback from the video game (e.g., in the form of one or more screenshots/screencasts and/or one or more data signals indicating any points scored in the video game). If, in this scenario, the computer system 100 happens to cause a series of actions in the video game that results in a reward being achieved (e.g., a score of +1 being achieved), then the computer system 100 might receive one or more screenshots or a screencast that represent the series of actions performed and a data signal (e.g., from the video game's point generator or point accumulator) that a point (+1) has been scored. In this relatively simple example, the computer system 100 may interpret that feedback as a positive reward (equal to a point of +1) and the feedback data may be provided to the RNN in a manner that causes the RNN to evolve to learn how better to control the video game based on the feedback, and other data, associated with the indicated scenario.

There are a variety of ways in which a screenshot or a screencast may be captured and fed back to the computer system 100. In a typical implementation, the screenshot or screencast is captured by a computer-based screen grabber, which may be implemented by a computer-based processor executing computer-readable instructions to cause the screen grab. A common screenshot, for example, may be created by the operating system or software running (i.e., being executed by the computer-based processor) on the computer-system. In some implementations, a screenshot or screen capture may also be created by taking a photo of the screen and storing that photo in computer-based memory. In some implementations, a screencast may be captured by any one of a variety of different screen casting software that may be stored in computer-based memory and executed by a computer-based processor. In some implementations, the computer-based screen grabber may be implemented with a hardware Digital Visual Interface (DVI) frame grabber card or the like.

At any particular point in time, the computer system 100 (agent) may receive a command input. The command input may be entered into the computer system 100 by a human user (e.g., through one of the system's I/O devices 108, such as a computer-based user terminal, in FIG. 1. For example, the human user may enter a command at a user workstation for the computer system 100 to “score 10 points in 15 time steps” instructing the computer system 100 to attempt to “score 10 points in 15 time steps.” The computer system's effectiveness in performing this particular goal—a specific, not necessarily optimum outcome in a specified amount of time—will depend on the degree of training received to date and the relevance of that training to the task at hand by the computer system (and its RNN).

Although an input command may be entered by a human user, in some instances, the command input may be generated by a computer-based command input generator, which may (or may not) be integrated into the computer system itself. Typically, the computer-based command input generator is implemented by a computer-based processor executing a segment of software code stored in computer-based memory. The commands generated by the computer-based command input generator in a sequence of command inputs may be random or not. In some instances, the sequence of commands so generated will follow a pattern intended to produce a robust set of data for training the RNN of the computer system in a short amount of time.

Generally speaking, at any point in time during a particular trial, data regarding past command inputs, actions caused by the agent 100 in the external environment in response to those command inputs, as well as any feedback data the agent 100 has received to date from the external environment (e.g., rewards achieved, which may be represented as vector-valued cost/reward data reflecting time, energy, pain and/or reward signals, and/or any other observations that the agent 100 has received to date, such as screenshots, etc.) represents all the information that the agent knows about its own present state and the state of the external environment at that time.

The trial represented in the flowchart of FIG. 3 begins at 322 in response to a particular command input (i.e., a specified goal reward plus a specified goal time horizon).

The command input may be self-generated (i.e., generated by the computer system 100 itself) or may have originated outside of the computer (e.g., by a human user entering command input parameters into the computer system 100 via one or more of the I/O devices 108 (e.g., a computer keyboard, mouse touch pad, etc.)). In some instances where the command input is self-generated, the computer system 100 may have a series of command inputs stored in its memory 106 that the processor 102 processes sequentially. In some instances where the command input is self-generated, the computer system 100 may have an algorithm for generating commands in a random or non-random manner and the computer processor 102 executes the algorithm periodically to generate new command inputs. It may be possible to generate command inputs in various other manners.

According to the illustrated flowchart, the computer system 100 (at 322) sets or assigns a value of 1 to a timer (t) of the computer system 100. This setting or assignment indicates that the current time step in the trial is 1 or that the trial is in its first time step. As the algorithm moves into subsequent time steps, the value in (t) is incremented by one (at 330) after executing each step. In some implementations, a time step may refer to any amount of time that it takes for the computer system 100 to execute one step (e.g., send an execute signal out into the environment at 326). In some implementations, a time step may be a second, a millisecond, or virtually any other arbitrary duration of time.

At step 324, the computer system 100 initializes a local variable for C (or C[A1]) of the type used to store controllers. In this step, the computer processor 102 may load a set of initialization data into the portion of the memory 108 that defines various parameters (e.g., weights, etc.) associated with the RNN. The initialization data may be loaded from a portion of the memory 108 that is earmarked for storing initialization data. This step establishes the RNN in a starting configuration, from which the configuration will change as the RNN is exposed to more and more data.

At step 326, the computer system 100 executes one step (or action). This (step 326) typically entails generating one or more control signals with the RNN, based on the command input, and sending the control signal(s) into the external environment. In this regard, the computer system typically has a wired or wireless transmitter (or transceiver) for transmitting the control signal.

Outside the computer system 100, the control signal is received, for example, at a destination machine, whose operation the computer system 100 is attempting to control or influence. Typically, the signal would be received from a wired or wireless connection at a receiver (or transceiver) at the destination machine. The signal is processed at destination machine or process and, depending on the signal processing, the machine may or may not react. The machine typically includes one of more sensors (hardware or software or a combination thereof) that can sense one or more characteristics (e.g., temperature, voltage, current, air flow, anything) at the machine following any reaction to the signal by the machine. The one or more sensors produce feedback data (including actual rewards produced and time required to produce those rewards) that can be transmitted back to the computer system 100. In this regard, the machine typically includes a transmitter (or transceiver) that transmits (via wired or wireless connection) a feedback signal that includes the feedback data back to the computer system 100. The feedback signal with the feedback data is received at a receiver (or transceiver) of the computer system 100. The feedback data is processed by the computer system 100 in association with the control signal that caused the feedback data and the command input (i.e., desired reward and time horizon inputs) associated with the control signal. In some implementations, each step executed is treated by the computer system as one time step.

The control signal sent (at 326) is produced as a function of the current command input (i.e., desired reward and time horizon) and the current state of the RNN in the computer-system. In this regard, the computer system 100 (at 326) determines the next step to be taken based on its RNN and produces one or more output control signals representative of that next step. The determinations made by computer system 100 (at 326) in this regard are based on the current state of the RNN and, as such, influenced by any data representing prior actions taken in the external environment to date as well as any associated feedback data received by the computer system 100 from the environment in response to (or as a result of) those actions. The associated feedback data may include data that represents any rewards achieved in the external environment, time required to achieve those rewards, as well as other feedback data originating from, and collected by, one or more feedback sensors in the external environment. The feedback sensors can be pure hardware sensors and/or sensors implemented by software code being executed by a computer-based processor, for example. The feedback can be provided back into the computer via any one or more wired or wireless communication connections or channels or combinations thereof.

Each control signal that the computer system 100 produces represents what the computer system 100 considers to be a next appropriate step or action by the machine in the external environment. Each step or action may (or may not) change the external environment and result in feedback data (e.g., from one or more sensors in the external environment) being returned to the computer system 100 and used in the computer system 100 to train the RNN.

In some instances, especially when the RNN has not been thoroughly trained for a particular external environment yet, the RNN/computer system 100 will not likely be able to produce a control signal that will satisfy a particular command input (i.e., a particular reward in a particular time horizon). In those instances, the RNN/computer system 100 may, by sending out a particular command, achieve some other reward or no reward at all. Nevertheless, even those instances where an action or series of actions fail to produce the reward/time horizon specified by the command input, data related to that action or series of actions may be used by the computer system 100 to train its RNN. That is because, even though the action or series of actions failed to produce the reward in the time horizon specified by the command input, the action or series of actions produced some reward—be it a positive reward, a negative reward (or loss), or a reward of zero—in some amount of time. And, the RNN of the computer system 100 can be (and is trained) to evolve based on an understanding that, under the particular set of circumstances, the particular observed action or series of actions, produced the particular observed reward in the particular amount of time. Once trained, subsequently, if a similar outcome is desired under similar circumstances, the computer system 100, using its better trained RNN, will be better able to better predict a successful course of action given the same or similar command input under the same or similar circumstances.

So, in some instances, especially where the environment external to the computer system 100 is largely unexplored and not yet well understood (e.g., not well represented by the current state of the RNN), the computer system 100 (at 326) may determine the next step (or action) to be taken based on the current command input (i.e., a specified goal reward plus a specified goal time horizon), and the current state of the RNN, in a seemingly random manner. Since the current state of the RNN at that particular point in time would not yet represent the environment external to the computer system particularly well, the one or more output signals produced by the computer system 100 to cause the next step (or action) in the environment external to the computer system 100 may be, or at least seem, largely random (i.e., disconnected from the goal reward plus time horizon specified by the current command input). Over time, however, as the computer system 100 and its RNN evolve, their ability to predict outcomes in the external environment improves.

At step 328, the computer system 100 determines whether the current trial is over. There are a variety of ways that this step may be accomplished and may depend, for example, on the nature of the trial itself. If, for example, a particular trial is associated with a certain number of time steps (e.g., based on an input command specifying a goal of trying to earn a reward of 10 points in 15 time steps), then the electronic/computer-based timer or counter (t) (which may be implemented in computer system 100) may be used to keep track of whether 15 time steps have passed or not. In such an instance, the computer system 100 (at step 328) may compare the time horizon from the input command (e.g., 15 time steps) with the value in the electronic/computer-based timer or counter (t).

If the computer system 100 (at step 328) determines that the current trial is over (e.g., because the value in the electronic/computer-based timer or counter (t) matches the time horizon of the associated input command or for some other reason), then the computer system 100 (at 332) exits the process. At that point, the computer system 100 may enter an idle state and wait to be prompted into the process (e.g., at 322) represented in FIG. 3 again. Such a prompt may come in the form of a subsequent command input being generated or input, for example. Alternatively, the computer system 100 may cycle back to 322 and generate a subsequent input command on its own.

If the computer system 100 (at step 328) determines that the current trial is not over (e.g., because the value in the electronic/computer-based timer or counter (t) does not match the time horizon of the associated command input, or the goal reward specified in the command input has not been achieved, or for some other reason), then the computer system 100 (at 332) increments the value in the electronic/computer-based timer or counter (t)—by setting t:=t+1—and the process returns, as indicated, to an earlier portion of algorithm A1 (e.g., step 340). In a typical implementation, this incrementing of the counter indicates that an additional time step has passed.

While algorithm A1 is happening, algorithm A2 is also happening, in parallel with algorithm 1. In accordance with the illustrated version of algorithm A2, the computer system 100 (at 342) conducts replay-training on previous behaviors (actions) and commands (actual rewards+time horizons). Typically, as indicated in the flowchart, during the course of a particular trial, algorithm 2 might circle back to replay-train its RNN multiple times, with algorithm 1 and algorithm 2 occasionally synchronizing with one another (see, e.g., 334/336, 338/340 in FIG. 3) between at least some of the sequential replay trainings.

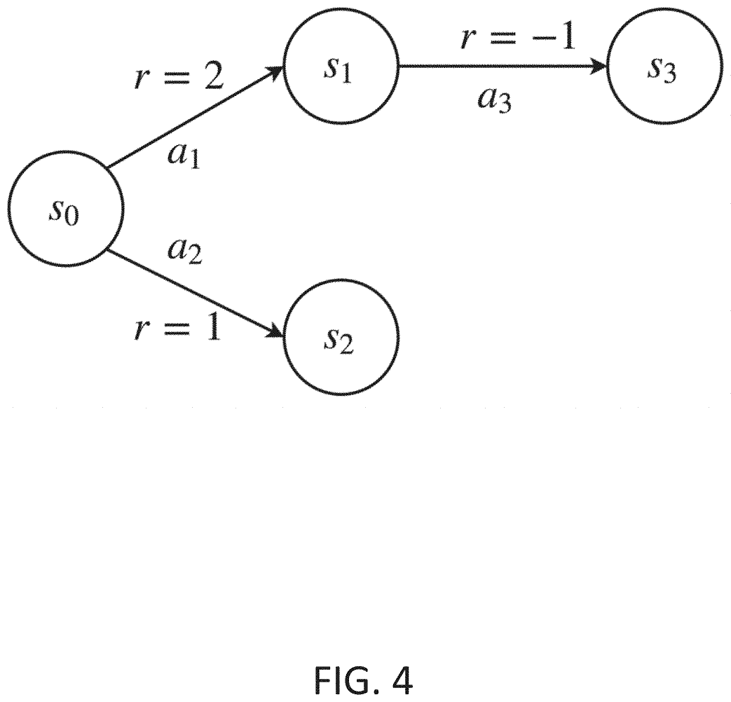

There are a variety of ways in which replay-training (at 342) may occur. In a typical implementation, the replay training includes training of the RNN based, at least in part, on data/information stored in the replay buffer of the computer system 100. For example, in some implementations, the agent 100 (at 342) may retrospectively create additional command inputs for itself (for its RNN) based on data in the replay buffer that represents past actual events that have occurred. This data (representing past actual events) may include information representing the past actions, resulting changes in state, and rewards achieved indicated in the exemplary state diagram of FIG. 4.

As an example, if the computer system 100 generates a reward of 4 in 2 time steps (while trying to achieve some other goal, let's say a reward of 10 in 2 time steps), then the system 100 might store (e.g., in replay buffer 110) the actual observed reward of 4 in 2 time steps in logical association with other information about that actual observed reward (including, for example, the control signal sent out that produced the actual observed reward (4) and time horizon (2 time steps), previously-received feedback data indicating the state of one or more characteristics of the external environment when the control signal was sent out, and, in some instances, other data that may be relevant to training the RNN to predict the behavior of the external environment. In that instance, the computer system 100 may (at step 342), using supervised learning techniques, enter into the RNN the actual observed reward (4) and actual observed time horizon (2 time steps), along with the information about the state of the external environment, the control signal sent, and (optionally) other information that might be relevant to training the RNN.

The state diagram of FIG. 4 represents a system (e.g., an external environment, such as a video game being controlled by a computer system 100 with an RNN) where each node in the diagram represents a particular state (s0, s1, s2, or s3) of the video game, each line (or connector) that extends between nodes represents a particular action (a1, a2, or a3) in the video game, and particular reward values r is associated with each action/change in state. In a typical implementation, the computer system 100 produces command inputs (e.g., control signals delivered into the video game via a corresponding I/O device) to cause the actions (a1, a2, a3) in the video game and in response to each action (a1, a2, a3) receives feedback (in the form of at least a corresponding one of the reward signals (r=2, r=1, r=−1)).

According to the illustrated diagram, each action caused a change in the state of the video game. More particularly, action a1 caused the video game to change from state s0 to state s1, action a2 caused the video game to change from state s0 to state s2, and action a3 caused the video game to change from state s1 to state s3. Moreover, according to the illustrated diagram, each action (or change of state) produced a particular reward value r. More particularly, action a1, which caused the video game to change from state s0 to state s1, resulted in a reward of 2. Likewise, action a2, which caused the video game to change from state s0 to state s2, resulted in a reward of 1. Finally, action a3, which caused the video game to change from state s1 to state s3, resulted in a reward of −1.

In this example, the actions, state changes, and rewards are based on past observed events. Some of these observed events may have occurred as a result of the computer system 100 aiming to cause the event observed (e.g., aiming to use action a1 to change state from s0 to s1 and produce a reward signal of 2), but, more likely, some (or all) of the observed events will have occurred in response to the computer system 100 aiming to cause something else to happen (e.g., the reward signal 2 may have been produced as a result of the computer system 100 aiming to produce a reward signal of 3 or 4).

More particularly, in one example, the computer system 100 may obtain at least some of the information represented in the diagram of FIG. 4 by acting upon a command input to achieve a reward of 5 in 2 time step. In response to that command input, the agent 100 may have produced an action that failed to achieve the indicated reward of 5 in 2 time step. However, in the course of attempting to achieve the indicated reward of 5 in 2 time steps, the agent 100 may have ended up actually achieving a reward of 2 in the first of the 2 time steps by implementing a first action a₁ that changed the environment from a first state s₀ to a second state s₁, and achieving a reward of −1 in a second of the two time steps by implementing a second action a₃ that changed the environment from the second state s₁ to a third state s₃. In this example, the agent 100 failed to achieve the indicated reward of 5 in 2 time steps, but will have ended up achieving a net reward of 1 in 2 time steps by executing two actions a₁, a₃ that changed the environment from a first state s₀ to a third state s₃.

To obtain other information represented in the diagram of FIG. 4, the computer system 100 may have acted upon a command input to achieve a reward of 2 in 1 time step. In response to that command input, the agent 100 produced an action that failed to achieve the indicated reward of 2 in 1 time step. However, in the course of attempting to achieve the indicated reward of 2 in 1 time step, the agent 100 ended up actually achieving a reward of 1 in 1 time step by implementing action a₂ that changed the environment from the first state s₀ to a fourth state s₂.

In training the RNN (at step 322 in FIG. 3), the computer system 100 may generate command inputs that match the observed events and use supervised learning to train the RNN to reflect that action a0 can cause the external environment to change from state s0 to s1 and produce a reward signal r=2, that action a3 can cause the external environment to change from state s1 to s3 and produce a reward signal r=−1, that actions a1 followed by a3 can cause the external environment to change from state s0 to state s3 and produce a collective reward of r=1 (i.e., 2-1), and that action a2 can cause the external environment to change from state s0 to state s2 and produce a reward signal of r=1. In this regard, the supervised learning process may include labeling each observed set of feedback data (e.g., indicating that state changed from s0 to s1 and produced a reward r=2) with a label, which may be computer-generated, that matches the associated action that was actually performed and observed to have produced the associated feedback data (e.g., state change and reward).

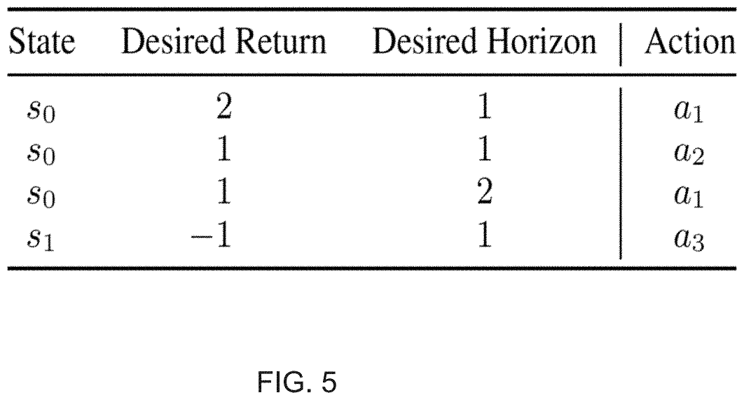

FIG. 5 is a table that shows the labels (under the “action” header) that would be generated and applied to each corresponding state, associated reward (“desired return”), and time horizon (“desired horizon”) based on the scenario represented in the diagram of FIG. 4.

In a typical implementation, some (or all) of the information represented in the diagram of FIG. 4 (past actions, associated state changes, associated rewards, and (optionally) other feedback data) may be stored, for example, in the computer system's computer-based memory (e.g., in a replay buffer or the like). This information is used (at step 335 in the FIG. 3 flowchart) to train the computer system/RNN, as disclosed herein, to better reflect and understand the external environment. As the RNN of the computer system 100 continues to be trained with more and more data, the RNN becomes better suited to predict correct actions to produce a desired outcome (e.g., reward/time horizon), especially in scenarios that are the same as or highly similar to those that the RNN/computer system 100 already has experienced.

In a typical implementation, the agent 100 trains the RNN (using gradient descent-based supervised learning (SL), for example) to map time-varying sensory inputs, augmented by the command inputs defining time horizons and desired cumulative rewards etc. to the already known corresponding action sequences. In supervised learning, a set of input and outputs are given and may be referred to as a training set. In this example, the training set would include historical data that the RNN actually has experienced including any sensory input data, command inputs and any actions that actually occurred. The goal of the SL process in this regard would be to train the RNN to behave as a function of sensory input data and command inputs to be a good predictor for a corresponding value of corresponding actions. In a typical implementation, the RNN gets trained in this regard by adjusting the weights associated with each respective connection in RNN. Moreover, the way those connection weights may be changed is based on the concept of gradient descent.

Referring again to FIG. 3, algorithm 1 and algorithm 2 occasionally synchronize with one another (see, e.g., 334/336, 338/340 in FIG. 3). In a typical implementation, the memory 106 in computer system 100 stores a first set of RNN parameters (e.g., weights, etc.) that algorithm 1 (A1) uses to identify what steps should be taken in the external environment (e.g., what signals to send to the external environment in response to a command input) and a second set of RNN parameters (which, in a typical implementation, starts out as a copy of the first set) on which algorithm 2 (A2) performs its replay training (at 335).

Over time, algorithm 1 (A1) collects more and more data about the external environment (which is saved in the replay buffer 110 can be used by algorithm 2 (A2) in replay-based training, at step 335). Periodically (at 336 to 334), the computer system 100 copies any such new content from the replay buffer 110 and pastes that new content into memory (e.g., another portion of the replay buffer 110 or other memory 106) for use by algorithm 2 (A2) in replay-based training (step 335). The time periods between sequential synchronizations (336 to 334) can vary or be consistent. Typically, the duration of those time periods may depend on the context of the external environment and/or the computer system 100 itself. In some instance, the synchronization (336 to 334) will occur after every step executed by algorithm 1 (A1). In some instances, the synchronization (336 to 334) will occur just before every replay-based training step 335 by algorithm 2 (A2). In some instances, the synchronization (336 to 334) will occur less frequently or more frequently.

Likewise, over time, the RNN parameters that algorithm 2 uses to train controller C[A2] evolve over time. These parameters may be saved in a section of computer memory 106. Periodically (at 338 to 340), the computer system 100 copies any such new content from that section of computer memory 106 and pastes the copied content into a different section of computer memory 106 (for C[A1]) that the RNN uses to identify steps to take (at 328). The time periods between sequential synchronizations (338 to 340) can vary or be consistent. Typically, the duration of those time periods may depend on the context of the external environment and/or the computer system 100 itself. In some instance, the synchronization (338 to 340) will occur after every replay-based training (335) by algorithm 2 (A2). In some instances, the synchronization (338 to 340) will occur just before every step executed by algorithm 1 (A1). In some instances, the synchronization (336 to 334) will occur less frequently or more frequently.

If an experience so far includes different but equally costly action sequences leading from some start to some goal, then the system 100 may learn to approximate the conditional expected values (or probabilities, depending on the setup) of appropriate actions, given the commands and other inputs. A single life so far may yield an enormous amount of knowledge about how to solve all kinds of problems with limited resources such as time/energy/other costs. Typically, however, it is desirable for the system 100 to solve user-given problems (e.g., to get lots of reward quickly and/or to avoid hunger (a negative reward)). In a particular real-world example, the concept of hunger might correspond to a real or virtual vehicle with near-empty batteries for example, which may be avoided through quickly reaching a charging station without painfully bumping against obstacles. This desire can be encoded in a user-defined command of the type (small desirable pain, small desirable time), and the system 100, in a typical implementation, will generalize and act based on what it has learned so far through SL about starts, goals, pain, and time. This will prolong the system's 100 lifelong experience; all new observations immediately become part of the system's growing training set, to further improve system's behavior in continual online fashion.

### 1 Introduction

For didactic purposes, below, we first introduce formally the basics of UDRL for deterministic environments and Markovian interfaces between controller and environment (Sec. 3), then proceed to more complex cases in a series of additional Sections.

### 2 Notation

More formally, in what follows, let m, n, o, p, q, u denote positive integer constants, and h, i, j, k, t, τ positive integer variables assuming ranges implicit in the given contexts. The i-th component of any real-valued vector, v, is denoted by vᵢ. To become a general problem solver that is able to run arbitrary problem-solving programs, the controller C of an artificial agent may be a general-purpose computer specially programmed to perform as indicated herein. In typical implementations, artificial recurrent neural networks (RNNs) fit this bill. The life span of our C (which could be an RNN) can be partitioned into trials T₁, T₂, . . . . However, possibly there is only one single, lifelong trial. In each trial, C tries to manipulate some initially unknown environment through a sequence of actions to achieve certain goals.

Let us consider one particular trial and its discrete sequence of time steps, t=1, 2, . . . , T.

At time t, during generalization of C's knowledge so far in Step 3 of Algorithm A1 or B1, C receives as an input the concatenation of the following vectors: a sensory input vector in(t)∈ [symbol] ^{m} (e.g., parts of in(t) may represent the pixel intensities of an incoming video frame), a current vector-valued cost or reward vector r(t)∈ [symbol] ⁿ (e.g., components of r(t) may reflect external positive rewards, or negative values produced by pain sensors whenever they measure excessive temperature or pressure or low battery load, that is, hunger), the previous output action out^{l}(t−1) (defined as an initial default vector of zeros in case of t=1; see below), and extra variable task-defining input vectors horizon(t)∈ [symbol] ^{p} (a unique and unambiguous representation of the current look-ahead time), desire(t)∈ [symbol] ⁿ (a unique representation of the desired cumulative reward to be achieved until the end of the current look-ahead time), and extra(t)∈ [symbol] ^{q} to encode additional user-given goals.

At time t, C then computes an output vector out(t)∈ [symbol] ^{o} used to select the final output action out^{l}(t). Often (e.g., Sec. 3.1.1) out(t) is interpreted as a probability distribution over possible actions. For example, out^{l}(t) may be a one-hot binary vector∈ [symbol] ^{o} with exactly one non-zero component, outᵢ^{l} (t=1 indicates action aⁱ in a set of discrete actions {a¹, a², . . . , a^{o}}, and outᵢ(t) the probability of aⁱ. Alternatively, for even o, out(t) may encode the mean and the variance of a multi-dimensional Gaussian distribution over real-valued actions from which a high-dimensional action out^{l}(t)∈ [symbol] ^{o/2} is sampled accordingly, e.g., to control a multi-joint robot. The execution of out^{l}(t) may influence the environment and thus future inputs and rewards to C.

Let all(t) denote the concatenation of out^{l}(t−1), in(t), r(t). Let trace(t) denote the sequence (all(1), all(2), . . . , all(t)).

### 3 Deterministic Environments with Markovian Interfaces

For didactic purposes, we start with the case of deterministic environments, where there is a Markovian interface between agent and environment, such that C's current input tells C all there is to know about the current state of its world. In that case, C does not have to be an RNN—a multilayer feedforward network (FNN) may be sufficient to learn a policy that maps inputs, desired rewards and time horizons to probability distributions over actions.

In a typical implementation, the following version of Algorithms A1 and A2 (also discussed above) run in parallel, occasionally exchanging information at certain synchronization points. They make C learn many cost-aware policies from a single behavioral trace, taking into account many different possible time horizons. Both A1 and A2 use local variables reflecting the input/output notation of Sec. 2. Where ambiguous, we distinguish local variables by appending the suffixes “[A1]” or “[A2],” e.g., C[A1] or t[A2] or in(t)[A1].

Algorithm A1: Generalizing Through a Copy of C (with Occasional Exploration)
1. Set t:=1. Initialize local variable C (or C[A1]) of the type used to store controllers.
2. Occasionally sync with Step 3 of Algorithm A2 to set C[A1]:=C[A2](since C[A2] is continually (e.g., regularly) modified by Algorithm A2).
3. Execute one step: Encode in horizon(t) the goal-specific remaining time, e.g., until the end of the current trial (or twice the lifetime so far). Encode in desire(t) a desired cumulative reward to be achieved within that time (e.g., a known upper bound of the maximum possible cumulative reward, or the maximum of (a) a positive constant and (b) twice the maximum cumulative reward ever achieved before). C observes the concatenation of all(t), horizon(t), desire(t) (and extra(t), which may specify additional commands—see Sec. 3.1.6 and Sec. 4). Then C outputs a probability distribution out(t) over the next possible actions. Probabilistically select out^{l}(t) accordingly (or set it deterministically to one of the most probable actions). In exploration mode (e.g., in a constant fraction of all time steps), modify out^{l}(t) randomly (optionally, select out^{l}(t) through some other scheme, e.g., a traditional algorithm for planning or RL or black box optimization [Sec. 6]—such details may not be essential for UDRL). Execute action out^{l}(t) in the environment, to get in(t+1) and r(t+1).
4. Occasionally sync with Step 1 of Algorithm A2 to transfer the latest acquired information about t[A1], trace(t+1)[A1], to increase C[A2]'s training set through the latest observations.
5. If the current trial is over, exit. Set t:=t+1. Go to 2.

### Algorithm A2: Learning Lots of Time & Cumulative Reward-Related Commands

1. Occasionally sync with A1 (Step 4) to set t[A2]:=t[A1], trace(t+1)[A2] trace(t+1)[A1].
2. Replay-based training on previous behaviors and commands compatible with observed time horizons and costs: For all pairs {(k, j); 1≤k≤j≤t}: train C through gradient descent-based backpropagation to emit action out^{l}(k) at time k in response to inputs all(k), horizon(k), desire(k), extra(k), where horizon(k) encodes the remaining time j−k until time j, and desire(k) encodes the total costs and rewards Σᵣ₌ₖ₊₁^{j=1}r(τ) incurred through what happened between time steps k and j. (Here extra(k) may be a non-informative vector of zeros—alternatives are discussed in Sec. 3.1.6 and See. 4.)
3. Occasionally sync with Step 2 of Algorithm A1 to copy C[A1]:=C[A2]. Go to 1.

3.1 Properties and Variants of Algorithms A1 and A2

3.1.1 Learning Probabilistic Policies Even in Deterministic Environments

In Step 2 of Algorithm A2, the past experience may contain many different, equally costly sequences of going from a state uniquely defined by in(k) to a state uniquely defined by in(j+1). Let us first focus on discrete actions encoded as one-hot binary vectors with exactly one non-zero component (Sec. 2). Although the environment is deterministic, by minimizing mean squared error (MSE), C will learn conditional expected values

out(k)=E(out^{l}|all(k),horizon(k),desire(k),extra(k))

of corresponding actions, given C's inputs and training set, where E denotes the expectation operator. That is, due to the binary nature of the action representation, C will actually learn to estimate conditional probabilities

outᵢ(k)=P(out^{l}=aᵢ|all(k),horizon(k),desire(k),extra(k))

of appropriate actions, given C's inputs and training set. For example, in a video game, two equally long paths may have led from location A to location B around some obstacle, one passing it to the left, one to the right, and C may learn a 50% probability of going left at a fork point, but afterwards there is only one fast way to B, and C can learn to henceforth move forward with highly confident actions, assuming the present goal is to minimize time and energy consumption.

UDRL is of particular interest for high-dimensional actions (e.g., for complex multi-joint robots), because SL can generally easily deal with those, while traditional RL generally does not. See Sec. 6.1.3 for learning probability distributions over such actions, possibly with statistically dependent action components.

3.1.2 Compressing More and More Skills into C

In Step 2 of Algorithm A2, more and more skills are compressed or collapsed into C.

3.1.3 No Problems with Discount Factors

Some of the math of traditional RL heavily relies on problematic discount factors. Instead of maximizing Σᵣ₌₁^{T}r(τ), many RL machines try to maximize Σᵣ₌₁^{T}γ^{τ}r(τ) or Σᵣ₌₁^{∞}γ^{τ}r(τ) (assuming unbounded time horizons), where the positive real-valued discount factor γ<1 distorts the real rewards in exponentially shrinking fashion, thus simplifying certain proofs (e.g., by exploiting that Σᵣ₌₁^{∞}γ^{τ}r(τ) is finite).

[symbol] , however, explicitly takes into account observed time horizons in a precise and natural way, does not assume infinite horizons, and does not suffer from distortions of the basic RL problem.

3.1.4 Representing Time/Omitting Representations of Time Horizons

What is a good way of representing look-ahead time through horizon(t)∈ [symbol] ^{p}? The simplest way may be p=1 and horizon(t)=t. A less quickly diverging representation is horizon(t)=Σᵣ₌₁^{t}1/r. A bounded representation is horizon(t)Σᵣ₌₁^{t} γ^{τ}r with positive real-valued γ<1. Many distributed representations with p>1 are possible as well, e.g., date-like representations.

In cases where C's life can be segmented into several time intervals or episodes of varying lengths unknown in advance, and where we are only interested in C's total reward per episode, we may omit C's horizon( )-input. C's desire( )-input still can be used to encode the desired cumulative reward until the time when a special component of C'extra( )-input switches from 0 to 1, thus indicating the end of the current episode. It is straightforward to modify Algorithms A1/A2 accordingly.

3.1.5 Computational Complexity

In a typical implementation, the replay of Step 2 of Algorithm A2 can be done in O(t(t+1)2) time per training epoch. In many real-world applications, such quadratic growth of computational cost may be negligible compared to the costs of executing actions in the real world. (Note also that hardware is still getting exponentially cheaper over time, overcoming any simultaneous quadratic slowdown.) See Sec. 3.1.8.

3.1.6 Learning a Lot from a Single Trial—What about Many Trials?

In a typical implementation, in Step 2 of Algorithm A2, for every time step, C learns to obey many commands of the type: get so much future reward within so much time. That is, from a single trial of only 1000 time steps, it may derive roughly half a million training examples conveying a lot of fine-grained knowledge about time and rewards. For example, C may learn that small increments of time often correspond to small increments of costs and rewards, except at certain crucial moments in time, e.g., at the end of a board game when the winner is determined. A single behavioral trace may thus inject an enormous amount of knowledge into C, which can learn to explicitly represent all kinds of long-term and short-term causal relationships between actions and consequences, given the initially unknown environment. For example, in typical physical environments, C could automatically learn detailed maps of space/time/energy/other costs associated with moving from many locations (at different altitudes) to many target locations encoded as parts of in(t) or of extra(t)—compare Sec. 4.1.

If there is not only one single lifelong trial, we may run Step 2 of Algorithm A2 for previous trials as well, to avoid forgetting of previously learned skills, like in the POWERPLAY framework.

3.1.7 how Frequently should One Synchronize Between Algorithms A1 and A2?

It depends a lot on the task and the computational hardware. In a real-world robot environment, executing a single action in Step 3 of A1 may take more time than billions of training iterations in Step 2 of A2. Then it might be most efficient to sync after every single real-world action, which immediately may yield for C many new insights into the workings of the world. On the other hand, when actions and trials are cheap, e.g., in simple simulated worlds, it might be most efficient to synchronize rarely.

3.1.8 on Reducing Training Complexity by Selecting Few Relevant Training Sequences

To reduce the complexity O(t(t+1)2) of Step 2 of Algorithm A2 (Sec. 3.1.5), certain SL methods will ignore most of the training sequences defined by the pairs (k, j) of Step 2, and instead select only a few of them, either randomly, or by selecting protoypical sequences, inspired by support vector machines (SVMs) whose only effective training examples are the support vectors identified through a margin criterion, such that (for example) correctly classified outliers do not directly affect the final classifier. In environments where actions are cheap, the selection of only few training sequences may also allow for synchronizing more frequently between Algorithms A1 and A2 (Sec. 3.1.7).

In some implementations, the computer processor of computer system 100, for example, may select certain sequences utilizing one of these methods.

Similarly, when the overall goal is to learn a single rewarding behavior through a series of trials, at the start of a new trial, a variant of A2 could simply delete/ignore the training sequences collected during most of the less rewarding previous trials, while Step 3 of A1 could still demand more reward than ever observed. Assuming that C is getting better and better at acquiring reward over time, this will not only reduce training efforts, but also bias C towards recent rewarding behaviors, at the risk of making C forget how to obey commands demanding low rewards.

In some implementations, the computer processor of computer system 100, for example, may select certain sequences utilizing one of these methods and compare the rewards of a particular trial with some criteria stored in computer-based memory, for example.

There are numerous other ways of selectively deleting past experiences from the training set to improve and speed up SL. In various implementations, the computer system 100 may be configured to implement any one or more of these.

### 4 Other Properties of the History as Command Inputs

A single trial can yield even much more additional information for C than what is exploited in Step 2 of Algorithm A2. For example, the following addendum to Step 2 trains C to also react to an input command saying “obtain more than this reward within so much time” instead of “obtain so much reward within so much time,” simply by training on all past experiences that retrospectively match this command.
2b. Additional replay-based training on previous behaviors and commands compatible with observed time horizons and costs for Step 2 of Algorithm A2: For all pairs {(k,j); 1≤k≤j≤t}: train C through gradient descent to emit action out^{l}(k) at time k in response to inputs all(k), horizon(k), desire(k), extra(k), where one of the components of extra(k) is a special binary input morethan(k):=1.0 (normally 0.0), where horizon(k) encodes the remaining time j−k until time j, and desire(k) encodes half the total costs and rewards Σᵣ₌ₖ₊₁^{j+1}r(τ) incurred between time steps k and j, or ¾ thereof, or ⅞ thereof, etc.

That is, in certain such implementations, C also learns to generate probability distributions over action trajectories that yield more than a certain amount of reward within a certain amount of time. Typically, their number greatly exceeds the number of trajectories yielding exact rewards, which will be reflected in the correspondingly reduced conditional probabilities of action sequences learned by C.

A corresponding modification of Step 3 of Algorithm A1 is to encode in desire(t) the maximum conditional reward ever achieved, given all(t), horizon(t), and to activate the special binary input morethan(t):=1.0 as part of extra(t), such that C can generalize from what it has learned so far about the concept of obtaining more than a certain amount of reward within a certain amount of time. Thus, UDRL can learn to improve its exploration strategy in goal-directed fashion.

In some implementations, the computer system 100, for example, may implement these functionalities.

4.1 Desirable Goal States/Locations

Yet another modification of Step 2 of Algorithm A2 is to encode within parts of extra(k) a final desired input in(j+1)(assuming q>m), such that C can be trained to execute commands of the type “obtain so much reward within so much time and finally reach a particular state identified by this particular input.” See Sec. 6.1.2 for generalizations of this. A corresponding modification of Step 3 of Algorithm A1 is to encode such desired inputs in extra(t), e.g., a goal location that has never been reached before. In some implementations, the computer system 100, for example, may implement these functionalities.

4.2 Infinite Number of Computable, History-Compatible Commands

There are many other computable functions of subsequences of trace(t) with bi-nary outputs true or false that yield true when applied to certain subsequences. In principle, such computable predicates could be encoded in Algorithm A2 as unique commands for C with the help of extra(k), to further increase C's knowledge about how the world works, such that C can better generalize when it comes to planning future actions in Algorithm A1. In practical applications, however, one can train C only on finitely many commands, which should be chosen wisely. In some implementations, the computer system 100, for example, may implement these functionalities.

### 5 Probabilistic Environments

In probabilistic environments, for two different time steps l≠h we may have all(l)=all(h), out(l)=out(h) but r(l+1)>r(h+1), due to “randomness” in the environment. To address this, let us first discuss expected rewards. Given all(l), all(h) and keeping the Markov assumption of Sec. 3, we may use C's command input desire(·) to encode a desired expected immediate reward of ½[r(l+1)+r(h+1)] which, together with all(h) and a horizon( ) representation of 0 time steps, should be mapped to out(h) by C, assuming a uniform conditional reward distribution.

More generally, assume a finite set of states s¹, s², . . . , s^{u}, each with an unambiguous encoding through C's in( ) vector, and actions a¹, a², . . . , a^{o} with one-hot encodings (Sec. 2). For each pair (sⁱ, a^{j}) we can use a real-valued variable zᵢⱼ to estimate the expected immediate reward for executing a^{j} in sⁱ. This reward is assumed to be independent of the history of previous actions and observations (Markov assumption).

zᵢⱼ can be updated incrementally and cheaply whenever a^{j} is executed in sⁱ in Step 3 of Algorithm A1, and the resulting immediate reward is observed. The following simple modification of Step 2 of Algorithm A2 trains C to map desired expected rewards (rather than plain rewards) to actions, based on the observations so far.
2* Replay-based training on previous behaviors and commands compatible with observed time horizons and expected costs in probabilistic Markov environments for Step 2 of Algorithm A2: For all pairs {(k, j); 1≤k≤j≤t}: train C through gradient descent to emit action out^{l}(k) at time k in response to inputs all(k), horizon(k), desire(k) (we ignore extra(k) for simplicity), where horizon(k) encodes the remaining time j−k until time j, and desire(k) encodes the estimate of the total expected costs and rewards=Σᵣ₌ₖ₊₁^{j+1}E(r(τ)), where the E(r(τ)) are estimated in the obvious way through the zᵢⱼ variables corresponding to visited states l executed actions between time steps k and j.

If randomness is affecting not only the immediate reward for executing a^{j} in sⁱ but also the resulting next state, then Dynamic Programming (DP) can still estimate in similar fashion cumulative expected rewards (to be used as command inputs encoded in desire( )), given the training set so far. This approach essentially adopts central aspects of traditional DP-based RL without affecting the method's overall order of computational complexity (Sec. 3.1.5).

From an algorithmic point of view, however, randomness simply reflects a separate, unobservable oracle injecting extra bits of information into the observations. Instead of learning to map expected rewards to actions as above, C's problem of partial observability can also be addressed by adding to C's input a unique representation of the current time step, such that it can learn the concrete reward's dependence on time, and is not misled by a few lucky pastexperiences.

In some implementations, the computer system 100 of FIG. 1 may be configured to perform the foregoing functionalities.

One might consider the case of probabilistic environments as a special case of partially observable environments discussed next in Sec. 6.

### 6 Partially Observable Environments

In case of a non-Markovian interface between agent and environment, C's current input does not tell C all there is to know about the current state of its world. A recurrent neural network (RNN) or a similar specially programmed general purpose computer may be required to translate the entire history of previous observations and actions into a meaningful representation of the present world state. Without loss of generality, we now focus on an implementation in which C is an RNN such as long short-term memory (“LSTM”) which has become highly commercial. Algorithms A1 and A2 above may be modified accordingly, resulting in Algorithms B1 and B2 (with local variables and input/output notation analoguous to A1 and A2, e.g., C[B1] or t[B2] or in(t)[B1]).

Algorithm B: Generalizing Through a Copy of C (with Occasional Exploration)
1. Set t:=1. Initialize local variable C (or C[B1]) of the type used to store controllers.
2. Occasionally sync with Step 3 of Algorithm B2 to do: copy C[B1]:=C[B2] (since C[B2] is continually modified by Algorithm B2). Run C on trace(t−1), such that C's internal state contains a memory of the history so far, where the inputs horizon(k), desire(k), extra(k), 1≤k<t are retrospectively adjusted to match the observed reality up to time t. One simple way of doing this is to let horizon(k) represent 0 time steps, extra(k) the null vector, and to set desire(k)=r(k+1), for all k (but many other consistent commands are possible, e.g., Sec. 4).
3. Execute one step: Encode in horizon(t) the goal-specific remaining time (see Algorithm A1). Encode in desire(t) a possible future cumulative reward, and in extra(t) additional goals, e.g., to receive more than this reward within the remaining time—see Sec. 4. C observes the concatenation of all(t), horizon(t)·desire(t), extra(t), and outputs out(t). Select action out^{l}(t) accordingly. In exploration mode (i.e., in a constant fraction of all time steps), modify out^{l}(t) randomly. Execute out^{l}(t) in the environment, to get in(t+1) and r(t+1).
4. Occasionally sync with Step 1 of Algorithm B2 to transfer the latest acquired information about t[B1], trace(t+1)[B1], to incrase C[B2]'s training set through the latest observations.
5. If the current trial is over, exit. Set t:=t+1. Go to 2.

### Algorithm B2: Learning Lots of Time & Cumulative Reward-Related Commands

1. Occasionally sync with B1 (Step 4) to set t[B2]:=t[B1], trace(t+1)[B2]:=trace(t+1)[B1].
2. Replay-based training on previous behaviors and commands compatible with observed time horizons and costs: For all pairs {(k,j); 1≤k≤j≤t} do: If k>1, run RNN C on trace(k−1) to create an internal representation of the history up to time k, where for 1≤i<k, horizon(i) encodes 0 time steps, desire(i)=r(i+1), and extra(i) may be a vector of zeros (see Sec. 4, 3.1.4, 6.1.2 for alternatives), Train RNN C to emit action out^{l}(k) at time k in response to this previous history (if any) and all(k), where the special command input horizon(k) encodes the remaining time j−k until time j, and desire(k) encodes the total costs and rewards Σᵣ₌ₖ₊₁^{j+1}r(τ) incurred through what happened between time steps k and j, while extra(k) may encode additional commands compatible with the observed history, e.g., Sec. 4, 6.1.2.
3. Occasionally sync with Step 2 of Algorithm B1 to copy C[B1]:=C[B2]. Go to 1.

In some implementations, the computer system 100 is configured to perform the foregoing functionalities to train its RNN (C).

6.1 Properties and Variants of Algorithms B1 and B2

Comments of Sec. 3.1 apply in analogous form, generalized to the RNN case. In particular, although each replay for some pair of time steps (k, j) in Step 2 of Algorithm B2 typically takes into account the entire history up to k and the subsequent future up to j, Step 2 is, in some embodiments, implemented in computer system 100 such that its computational complexity is still only O(t²) per training epoch (compare Sec. 3.1.5).

6.1.1 Retrospectively Pretending a Perfect Life so Far

Note that during generalization in Algorithm B1, RNN C always acts as if its life so far has been perfect, as if it always has achieved what it was told, because its command inputs are retrospectively adjusted to match the observed outcome, such that RNN C is fed with a consistent history of commands and other inputs.

6.1.2 Arbitrarily Complex Commands for RNNs as General Computers

Recall Sec. 4. Since RNNs can be implemented with specially-programmed general computers, we can train an RNN C on additional complex commands compatible with the observed history, using extra(t) to help encoding commands such as: “obtain more than this reward within so much time, while visiting a particular state (defined through an extra goal input encoded in extra(t)) at least 3 times, but not more than 5 times.” That is, we can train C to obey essentially arbitrary computable task specifications that match previously observed traces of actions and inputs. Compare Sec. 4, 4.2. (To deal with (possibly infinitely) many tasks, system 100 can order tasks by the computational effort required to add their solutions to the task repertoire (e.g., stored in memory)).

6.1.3 High-Dimensional Actions with Statistically Dependent Components

As mentioned in Sec. 3.1.1, UDRL is of particular interest for high-dimensional actions, because SL can generally easily deal with those, while traditional RL generally does not.

Let us first consider the case of multiple trials, where out(k)∈ [symbol] ^{o} encodes a probability distribution over high-dimensional actions, where the i-th action component outᵢ^{l}(k) is either 1 or 0, such that them am at most 2^{o} possible actions.

C can be trained, in such instances, by Algorithm B2 to emit out(k), given C's input history. In some implementations, this may be relatively straightforward under the assumption that the components of out^{l}(·) are statistically independent of each other, given C's input history.

In general, however, they are not. For example, a C controlling a robot with 5 fingers should often send similar, statistically redundant commands to each finger, e.g., when closing its hand.

To deal with this, Algorithms B1 and B2 can be modified in a straightforward way. Any complex high-dimensional action at a given time step can be computed/selected incrementally, component by component, where each component's probability also depends on components already selected earlier.

More formally, in Algorithm B1 we can decompose each time step t into o discrete micro time steps \hat{t}(1), \hat{t}(2), . . . \hat{t}(o) (see [43], Sec. on “more network ticks than environmental ticks”). At \hat{t}(1) we initialize real-valued variable out₀^{l}(t)=0. During \hat{t}(i), 1≤i≤o, C computes outᵢ(t), the probability of outᵢ^{l}(t) being 1, given C's internal state (based on its previously observed history) and its current inputs all(t), horizon(t), desire(t), extra(t) and outᵢ₊₁^{l} (t) (observed through an additional special action input unit of C). Then outᵢ^{l}(t) is sampled accordingly, and for i<o used as C's new special action input at the next micro time step \hat{t}(i+1).

Training of C in Step 2 of Algorithm B2 has to be modified accordingly. There are similar modifications of Algorithms B1 and B2 for Gaussian and other types of probability distributions.

6.1.4 Computational Power of RNNs: Generalization & Randomness Vs. Determinism

First, recall that Sec. 3.1.1 pointed out how an FNN-based C of Algorithms A1/A2 in general will learn probabilistic policies even in deterministic environments, since, in a typical implementation, at a given time t, C can perceive only the recent all(t) but not the entire history trace(t), reflecting an inherent Markov assumption.

If there is only one single lifelong trial, however, this argument may not hold for the RNN-based C of Algorithms B1/B2, because at each time step, an RNN could in principle uniquely represent the entire history so far, for instance, by learning to simply count the time steps.

This is conceptually very attractive. We do not even have to make any probabilistic assumptions any more. Instead, [symbol] simply learns to map histories and commands directly to high-dimensional deterministic actions out^{l}(·):=out(·)∈ [symbol] ^{o}. (This tends to be hard for traditional RL.)

Even in seemingly probabilistic environments (Sec. 5), an RNN C could learn deterministic policies, taking into account the precise histories after which these policies worked in the past, assuming that what seems random actually may have been computed by some deterministic (initially unknown) algorithm, e.g., a pseudorandom number generator.

To illustrate the conceptual advantages of single life settings, let us consider a simple task where an agent (e.g., a vehicle in the external environment) can pass an obstacle either to the left or to the right, using continuous actions in [0,1] defining angles of movement, e.g., 0.0 means go left, 0.5 go straight (and hit the obstacle), 1.0 go right.

First consider an episodic setting and a sequence of trials where C is reset after each trial. Suppose actions 0.0 and 1.0 have led to high reward 10.0 equally often, and no other actions such as 0.3 have triggered high reward. Given reward input command 10.0, the agent's RNN C will learn an expected output of 0.5, which of course is useless as a real-valued action-instead the system 100, in this instance, has to interpret this as an action probability based on certain assumptions about an underlying distribution (Sec. 3, 5, 6.1.3). Note, however, that Gaussian assumptions may not make sense here.

On the other hand, in a single life with, say, 10 subsequent sub-trials, C can learn arbitrary history-dependent algorithmic conditions of actions, e.g.: in trials 3, 6, 9, action 0.0 was followed by high reward. In trials 4, 5, 7, action 1.0 was. Other actions 0.4, 0.3, 0.7, 0.7 in trials 1, 2, 8, 10 respectively, yielded low reward. By sub-trial 11, in response to reward command 10.0, C should correctly produce either action 0.0 or 1.0 but not their mean 0.5.

In additional sub-trials, C might even discover complex conditions such as: if the trial number is divisible by 3, then choose action 0.0, else 1.0. In this sense, in single life settings, life is getting conceptually simpler, not harder. Because the whole baggage associated with probabilistic thinking and a priori assumptions about probability distributions and environmental resets (see Sec. 5) is getting irrelevant and can be ignored.

On the other hand, C's success in case of similar commands in similar situations at different time steps will now all depend on its generalization capability. For example, from its historic data, it may learn in step 2 of Algorithm B2 when precise time stamps are important and when to ignore them.

Even in deterministic environments, C might find it useful to invent a variant of probability theory to model its uncertainty, and to make seemingly “random” decisions with the help of a self-invented deterministic internal pseudorandom generator (which, in some instances, is integrated into computer system 100 and implemented via the processor executing software stored in memory). However, in general, no probabilistic assumptions (such as the above-mentioned overly restrictive Gaussian assumption) should be imposed onto C a priori.

To improve C's generalization capability, regularizers can be used during training in Step 2 of Algorithm B2. See also Sec. 3.1.8. In various implementations, one or more regularizers may be incorporated into the computer system 100 and implemented as the processor executing software residing in memory. In some implementations, a regularizer can provide an extra error function to be minimized, in addition to the standard error function. The extra error function typically favors simple networks. For example, its effect may be to minimize the number of bits needed to encode the network. For example, by setting as many weights as possible to zero, and keeping only those non-zero weights that are needed to keep the standard error low. That is, simple nets are preferred. This can greatly improve the generalization ability of the network.

6.1.5 RNNs With Memories of Initial Commands

There are variants of UDRL with an RNN-based C that accepts commands such as “get so much reward per time in this trial” only in the beginning of each trial, or only at certain selected time steps, such that desire(·) and horizon(·) do not have to be updated any longer at every time step, because the RNN can learn to internally memorize previous commands. However, then C must also somehow be able to observe at which time steps t to ignore desire(t) and horizon(t). This can be achieved through a special marker input unit whose activation as part of extra(t) is 1.0 only if the present desire(t) and horizon(t) commands should be obeyed (otherwise this activation is 0.0). Thus, C can know during the trial: The current goal is to match the last command (or command sequence) identified by this marker input unit. This approach can be implemented through modifications of Algorithms B1 and B2.

6.1.6 Combinations with Supervised Pre-Training and Other Techniques

C can be pre-trained by SL to imitate teacher-given trajectories. The corresponding traces can simply be added to C's training set of Step 2 of Algorithm B2. Similarly, traditional RL methods or AI planning methods can be used to create additional behavioral traces for training C. For example, we may use the company NNAISENSE's winner of the NIPS 2017 “learning to run” competition to generate several behavioral traces of a successful, quickly running, simulated 3-dimensional skeleton controlled through relatively high-dimensional actions, in order to pre-train and initialize C. C may then use UDRL to further refine its behavior.

### 7 Compress Successful Behaviors into a Compact Standard Policy Network without Command Inputs

In some implementations, C may learn a possibly complex mapping from desired rewards, time horizons, and normal sensory inputs, to actions. Small changes in initial conditions or reward commands may require quite different actions. A deep and complex network may be necessary to learn this. During exploitation, however, in some implementations, the system 100 may not need this complex mapping any longer; instead, it may just need a working policy that maps sensory inputs to actions. This policy may fit into a much smaller network.

Hence, to exploit successful behaviors learned through algorithms A1/A2 or B1/B2, the computer system 100 may simply compress them into a policy network called CC, as described below.

Using the notation of Sec. 2, the policy net CC is like C, but without special input units for the command inputs horizon(·), desire(·), extra(·). We consider the case where CC is an RNN living in a partially observable environment (Sec. 6).

### Algorithm Compress (Replay-Based Training on Previous Successful Behaviors):

1. For each previous trial that is considered successful: Using the notation of Sec.2. For 1≤k≤T do: Train RNN CC to emit action out^{l}(k) at time k in response to the previously observed part of the history trace(k−1).

For example, in a given environment, UDRL can be used to solve an RL task requiring the achievement of maximal reward/minimal time under particular initial conditions (e.g., starting from a particular initial state). Later, Algorithm Compress can collapse many different satisfactory solutions for many different initial conditions into CC, which ignores reward and time commands.

### 8 Imitate a Robot, to Make it Learn to Imitate You!

The concept of learning to use rewards and other goals as command inputs has broad applicability. In particular, we can apply it in an elegant way to train robots on learning by demonstration tasks considered notoriously difficult in traditional robotics. We will conceptually simplify an approach for teaching a robot to imitate humans.

For example, suppose that an RNN C should learn to control a complex humanoid robot with eye-like cameras perceiving a visual input stream. We want to teach it complex tasks, such as assembling a smartphone, solely by visual demonstration, without touching the robot—a bit like we would teach a child. First, the robot must learn what it means to imitate a human. Its joints and hands may be quite different from a human's. But you can simply let the robot execute already known or even accidental behavior. Then simply imitate it with your own body! The robot tapes a video of your imitation through its cameras. The video is used as a sequential command input for the RNN controller C (e.g., through parts of extra( ), desire( ), horizon( )), and C is trained by SL to respond with its known, already executed behavior. That is, C can learn by SL to imitate you, because you imitated C.

Once C has learned to imitate or obey several video commands like this, let it generalize: do something it has never done before, and use the resulting video as a command input.

In case of unsatisfactory imitation behavior by C, imitate it again, to obtain additional training data. And so on, until performance is sufficiently good. The algorithmic framework Imitate-Imitator formalizes this procedure.

### Algorithmic Framework: Imitate-Imitator

1. Initialization: Set temporary integer variable i:=0.
2. Demonstration: Visually show to the robot what you want it to do, while it videotapes your behavior, yielding a video V.
3. Exploitation/Exploration: Set i:=i+1. Let RNN C sequentially observe V and then produce a trace Hⁱ of a series of interactions with the environment (if in exploration mode, produce occasional random actions). If the robot is deemed a satisfactory imitator of your behavior, exit.
4. Imitate Robot: Imitate Hⁱ with your own body, while the robot records a video Vⁱ of your imitation.
5. Train Robot: For all k, 1≤k≤i train RNN C through gradient descent to sequentially observe V^{k} (plus the already known total vector-valued cost R^{k} of H^{k}) and then produce H^{k}, where the pair (V^{k},R^{k}) is interpreted as a sequential command to perform H^{k} under cost R^{k}. Go to Step 3 (or to Step 2 if you want to demonstrate anew).

It is obvious how to implement variants of this procedure through straightforward modifications of Algorithms B1 and B2 along the lines of Sec. 4, e.g., using a gradient-based sequence-to-sequence mapping approach based on LSTM.

Of course, the Imitate-Imitator approach is not limited to videos. All kinds of sequential, possibly multi-modal sensory data could be used to describe desired behavior to an RNN C, including spoken commands, or gestures. For example, observe a robot, then describe its behaviors in your own language, through speech or text. Then let it learn to map your descriptions to its own corresponding behaviors. Then describe a new desired behavior to be performed by the robot, and let it generalize from what it has learned so far.

### Part II: Training Agents Using UDRL

### 1 UDRL—Goals

Unless otherwise indicated, this part of the application relates to the rest of the application and has as main goals to present a concrete instantiation of UDRL and practical results that demonstrate the utility of the ideas presented. Finally, we show two interesting properties of UDRL agents: their ability to naturally deal with delayed rewards, and to respond to commands desiring varying amount of total episodic returns (and not just the highest).

### 2 Terminology & Notation

In what follows, s, a and r denote state, action, and reward respectively. The sets of s and a (S and [symbol] ) depend on the environment. Right subscripts denote time indices (e.g. sₜ,t∈ [symbol] ⁰). We consider Markovian environments with scalar rewards (r∈ [symbol] ) as is typical, but the general principles of UDRL are not limited to these settings. A policy π:S→ [symbol] is a function that selects an action in a given state. A stochastic policy maps a state to a probability distribution over actions. Each episode consists of an agent's interaction with its environment starting in an initial state and ending in a terminal state while following any policy. A trajectory τ is the sequence [symbol] (sₜ,aₜ,rₜ,sₜ₊₁) [symbol] , t=0, . . . , T−1 describing an episode of length T. A subsequence of a trajectory is a segment or a behavior (denoted κ), and the cumulative reward over a segment is the return.

2.1 Understanding Knowledge Representation in UDRL

Before proceeding with practical implementations, we briefly discuss the details of UDRL for episodic tasks. These are tasks where the agent interactions are divided into episodes of a maximum length.

In contrast to some conventional RL algorithms, for example, the basic principle of UDRL is neither reward prediction nor maximization, but can be described as reward interpretation. Given a particular definition of commands, it trains a behavior function that encapsulates knowledge about past observed behaviors compatible with all observed (known) commands. Throughout below, we consider commands of the type: “achieve a desired return d^{r} in the next d^{h} time steps from the current state”. For any action, the behavior function B_{T} produces the probability of that action being compatible with achieving the command based on a dataset of past trajectories T. In discrete settings, we define it as

B_{T}(a|s,d^{r},d^{h})=N_{κ}^{a}((s,d^{r},d^{h})/N_{κ}(s,d^{r},d^{h}), (1)

where N_{κ}(s, d^{r}, d^{h}) is the number of segments in that start in state s, have length d^{h} and total reward d^{r}, and N^{a} (s, d^{r}, d^{h}) is the number of such segments where the first action was a.

Consider the simple deterministic Markovian environment represented in FIG. 4 in which all trajectories start in s₀ or s₁ and end in s₂ or s₃. B can be expressed in a simple tabular form, as in FIG. 5 (and stored in computer-based memory as such), conditioned on the set of all unique trajectories in this environment (there are just three). Intuitively, it answers the question: “if an agent is in a given state and desires a given return over a given horizon, which action should it take next based on past experience?”. Note that B_{T}, in a typical implementation, is allowed to produce a probability distribution over actions even in deterministic environments since there may be multiple possible behaviors compatible with the same command and state. For example, this would be the case in a toy environment if the transition s₀→s₂ had a reward of 2.

B_{T} is generally conditioned on the set of trajectories used to construct it. Given external commands, an agent can use it to take decisions using Equation 1, but, in some instances, this may be problematic (e.g., in some practical settings). Computing B_{T}(a) may involve a rather expensive search procedure over the agent's entire past experiences. Moreover, with limited experience or in continuous-valued state spaces, it is likely that no examples of a segment with the queried s, d^{r} and d^{h} exist. Intuitively, there may be a large amount of structure in the agent's experience that can be exploited to generalize to such situations, but pure memory does not allow this simple exploitation of regularities in the environment. For example, after hitting a ball a few times and observing its resulting velocity, an agent should be to understand how to hit the ball to obtain new velocities that it never observed in the past.

The solution is to learn a function to approximate B_{T} that distills the agent's experience, makes computing the conditional probabilities fast and enables generalization to unseen states and/or commands. Using a loss function L, the behavior function can be estimated as

$${B}_{T} = {argmin}_{B} {\sum }_{( {t}_{1 ,} {t}_{2} )} L ( B ( {s}_{{t}_{1}} , {d}^{r} , {d}^{h} ) , {a}_{{t}_{1}} ) , \qquad ( 2 )$$

where for all τ∈ [symbol] , 0<t₁<t₂<len(τ),

$${d}^{r} = {\sum }_{t = {t}_{1}}^{{t}_{2}} {r}_{t} and {d}^{h} = {t}_{2} - {t}_{1} .$$

Here len(τ) is the length of any trajectory τ. For a suitably parameterized B, the system 100 may use the cross-entropy between the observed and predicted distributions of actions as the loss function. Equivalently, the system 100 may search for parameters that maximize the likelihood that the behavior function generates the actions observed in, using the traditional tools of supervised learning. Sampling input-target pairs for training is relatively simple. In this regard, the system 100 may sample time indices (t₁, t₂) from any trajectory, then construct training data by taking its first state (sₜ) and action (aₜ), and compute the values of d^{r} and d^{h} for it retrospectively. In some implementations, this technique may help the system avoid expensive search procedures during both training and inference. A behavior function for a fixed policy can be approximated by minimizing the same loss over the trajectories generated using the policy.

2.2 UDRL for Maximizing Episodic Returns

In a typical implementation, a behavior function compresses a large variety of experience potentially obtained using many different policies into a single object. Can a useful behavior function be learned in practice? Furthermore, can a simple off-policy learning algorithm based purely on continually training a behavior function solve interesting RL problems? To answer these questions, we now present an implementation of Algorithm A1, discussed above—as a full learning algorithm used for the experiments in this paper. As described in the following high-level pseudo-code in Algorithm 1, it starts by initializing an empty replay buffer to collect the agent's experiences during training, and filling it with a few episodes of random interactions. The behavior function of the agent is initialized randomly and periodically improved using supervised learning on the replay buffer in the computer system's 100 memory. After each learning phase, it is used to act in the environment to collect new experiences and the process is repeated. The remainder of this section describes each step of the algorithm and introduces the hyperparameters.

```
Algorithm 1 Upside-Down Reinforcement Learning: High-level Description.
  1: Initialize replay buffer with warm-up episodes using random actions  // Section 2.2.1
  2: Initialize a behavior function  // Section 2.2.2
  3: While stopping criterion is not reached do
  4:  Improve the behavior function by training on data in replay buffer  // Exploit; Section 2.2.3
  5:  Sample exploratory commands  // Section 2.2.4
  6:  Generate episodes using Algorithm 2 and add to replay buffer  // Explore; Section 2.2.5
  7:  if evaluation required then
  8:  Evaluate agent using Algorithm 2  // Section 2.2.6
  9:  end if
10: end while
```

2.2.1 Replay Buffer

Typically, UDRL does not explicitly maximize returns, but instead may rely on exploration to continually discover higher return trajectories for training. To reach high returns faster, the inventors have found it helpful to use a replay buffer (e.g., in computer system 100) with the best Z trajectories seen so far, sorted by increasing return, where Z is a fixed hyperparameter. In a typical implementation, the sorting may be performed by the computer-based processor in computer system 100 based on data stored in the system's computer-based memory. The trade-off is that the trained agent may not reliably obey low return commands. An initial set of trajectories may be generated by the computer system 100 by executing random actions in the environment.

2.2.2 Behavior Function

At any time t, the current behavior function B produces an action distribution P(aₜ|sₜ,cₜ)=B(sₜ,cₜ; θ) for the current state sₜ and command cₜ:=(dₜ^{r},dₜ^{h}), where dₜ^{r}∈ [symbol] is the desired return, dₜ^{h}∈ [symbol] is the desired horizon, and θ is a vector of trainable parameters initialized randomly at the beginning of training. Given an initial command c₀, a new trajectory can be generated using Algorithm 2 by sampling actions according to B and updating the current command using the obtained rewards and time left. We note two implementation details: dₜ^{h} is always set to max(dₗ^{h},1) such that it is a valid time horizon, and dₜ^{r} is clipped such that it is upper-bounded by (an estimate of) the maximum return achievable in the environment. This avoids situations where negative rewards (rₜ) can lead to desired returns that are not achievable from any state (see Algorithm 2; line 8).

```
Algorithm 2 Generate an Episode for an initial command using the Behavioral Function.
Input: Initial command c₀ = (d₀^{r}, d₀^{h}), Initial state s₀, Behavior function B(; θ)
Output: Episode data E
  1: E ← Ø
  2: t ← 0
  3: while episode is no over do
  4:  Compute P(aₜ|sₜ, cₜ) = B(sₜ, cₜ; θ)
  5:  Execute aₜ ~ P(aₜ|sₜ, cₜ) to obtain reward rₜ and next state sₜ₊₁ from the environment
  6:  Append (sₜ, aₜ, rₜ) to E
  7:  sₜ ← sᵢ₊₁ // Update state
  8:  dₜ^{r} ← dₜ^{r} − rₜ; dₜ^{h} ← dₜ^{h} − 1 // Update desired reward and horizon
  9:  cₜ ← (dₗ^{r}, dₜ^{h})
10:  t ← t + 1
11: end while
```

2.2.3 Training the Behavior Function

As discussed in Section 2.1. B is trained using supervised learning on input-target examples from any past episode by minimizing the loss in Equation 2. To draw a training example from a random episode in the replay buffer, time step indies t₁ and t₂ are selected randomly such that 0≤t₁<t₂≤T, where T is the length of the selected episode. Then the input for training B is (sₜ_{₁}, (d^{r},d^{h})), where d^{r}=Σₜ₌ₜ_{₁}^{t}^{₂} rₜ, d^{h}=t₂−t₁, and the target is aₜ_{₁}, the action taken at t₁. For all experiments in this paper, only “trailing segments” were sampled from each episode, i.e., we set t₂=T−1. This discards a large amount of potential training examples but is a good fit for episodic tasks where the goal is to obtain high total rewards until the end of each episode. It also makes training easier, since the behavior function only needs to learn to execute a subset of possible commands. A fixed number of training iterations using methods based on an article, which is incorporated by reference in its entirety, entitled A method for stochastic optimization, by Kingma, D. and Ba, J. Adam, in arXiv preprint arXiv:1912.13465, 2019, were performed in each training step in these experiments.

2.2.4 Sampling Exploratory Commands

After each training phase, the agent can (and, in some implementations, does) attempt to generate new, previously infeasible behavior, potentially achieving higher returns. To profit from such “exploration through generalization,” the system 100 first creates a set of new initial commands c₀ to be used in Algorithm 2. In an exemplary implementation, the computer system 100 may use the following procedure as a simplified method of estimating a distribution over achievable commands from the initial state and sampling from the ‘best’ achievable commands:
1. A number of episodes from the end of the replay buffer (i.e., with the highest returns) are selected (e.g., by the processor of the computer system 100). This number may be obtained, in some instances, from the system's computer-based memory. This number is a hyperparameter and remains fixed during training.
2. The exploratory desired horizon d^{h} is set to the mean of the lengths of the selected episodes. In this regard, the computer-based processor may calculate the mean of the lengths of the selected episodes based on the characteristics of the selected episodes.
3. The exploratory desired returns d^{r} are sampled, by the computer-based processor of system 100, from the uniform distribution [M, M+S] where M is the mean and S is the standard deviation of the selected episodic returns.

This procedure was chosen due to its simplicity and ability to adjust the strategy using a single hyperparameter. Intuitively, it tries to generate new behavior (aided by stochasticity) that achieves returns at the edge of the best-known behaviors in the replay. For higher dimensional commands, such as those specifying target states, different strategies that follow similar ideas can be designed and implemented by the computer system 100. In general, it can be very important to select exploratory commands that lead to behavior that is meaningfully different from existing experience so that it drives learning progress. An inappropriate exploration strategy can lead to very slow or stalled learning.

2.2.5 Generating Experience

In a typical implementation, once the exploratory commands are sampled, the computer-based processor of system 100 generates new episodes of interaction by using Algorithm 2, which may work by repeatedly sampling from the action distribution predicted by the behavior function and updating its inputs for the next step. Typically, a fixed number of episodes are generated in each iteration of learning, and are added (e.g., by the computer-based processor) to the replay buffer.

2.2.6 Evaluation

In some implementations, Algorithm 2 is also used to evaluate the agent at any time using evaluation commands derived from the most recent exploratory commands. For simplicity, we assume that returns/horizons similar to the generated commands are feasible in the environment, but in general this relationship can be learned by modeling the conditional distribution of valid commands. The initial desired return d^{r} is set to the lower bound of the desired returns from the most recent exploratory command, and the initial desired horizon d^{h} is reused. For tasks with continuous-valued actions, we follow the convention of using the mode of the action distribution for evaluation.

### 3 Experiments

Our experiments were designed to a) determine the practical feasibility of UDRL, and, b) put its performance in context of traditional RL algorithms. We compare to Double Deep Q-Networks (DQN, Mnih et al, Human-level Control Through Deep Reinforcement Learning, Nature, 518 (7540):529-533, 2015; and Van Hasselt, et al., Deep Reinforcement Learning with Double Q-Learning, in Thirteenth AAAI Conference on Artificial Intelligence, 2016.) and Advantage Actor-Critic (A2C; synchronous version of the algorithm proposed by Mnih et al. in Asynchronous Methods for Deep Reinforcement Learning, arXiv:1602.01783[cs], February 2016) for environments with discrete actions, and Trust Region Policy Optimization (“TRPO,” Schulman et al., Trust Region Policy Optimization, in International Conference on Machine Learning, pp 1889-1897, 2015), Proximal Policy Optimization (“PPO,” Schulman, et al. Proximal Policy Optimization Algorithms, in arXiv preprint arXiv:1707.06347, 2017) and Deep Deterministic Policy Gradient (“DDPG,” Lillicrap, et al. Continuous Control with Deep Reinforcement Learning, arXiv preprint arXiv:1509.02971, 2015) for environments with continuous actions. In some respects, these algorithms are recent precursors of the current state-of-the-art, embody the principles of value prediction and policy gradients from which UDRL departs, and derive from a significant body of research.

All agents were implemented using fully-connected feed-forward neural networks, except for TakeCover-v0 where we used convolutional networks. The command inputs were multiplied by a scaling factor kept fixed during training. Simply concatenating commands with states lead to very inconsistent results, making it extremely difficult to find good hyperparameters. We found that use of architectures with fast weights (Schmidhuber, Learning to Control Fast-weight Memories: An Alternative to Dynamic Recurrent Networks, Neural Computation, 4(1):131-139, 1992)—where outputs of some units are weights of other connections—considerably improved reliability over multiple runs. Such networks have been used for RL in the past, and can take a variety of forms. We included two of the simplest choices in our hyperparameter search: gating (as used in Long Short-Term Memory (“LSTM,” Hochreiter and Schmidhuber, Long Short-Term Memory, Neural Computation, 9(8):1735-1780, 1997) and bilinear (Jayakumar, et al., Multiplicative Interactions and Where to Find Them, in International Conference on Learning Representations, 2020), using them only at the first layer in fully-connected networks and at the last layer in convolutional ones. This design makes it difficult to ignore command inputs during training.

We use environments with both low and high-dimensional (visual) observations, and both discrete and continuous-valued actions: LunarLander-v2 based on Box2D (Catto, et al. Box2D/A 2D Physics Engine for Games, 2014), TakeCover-v0 based on VizDoom (Kempka, et al., A Doom-Based AI Research Platform for Visual Reinforcement Learning, in 2016 IEEE Conference on Computational Intelligence and Games (CIG), pp 1-8, IEEE, 2016) and Swimmer-v2& InvertedDoublePendulum-v2 based on the MuJoCo simulator (Todorov et al. A Physics Engine for Model-Based Control in 2012 IEEE/RSJ International Conference on Intelligent Robots and Systems, pp. 5026-5033, IEEE, 2012), available in the Gym library (Brockman, et al. OpenAI Gym, arXivpreprint arXiv:1606.01540, 2016). These environments are useful for benchmarking but represent solved problems so our goal is not to obtain the best possible performance, but to ensure rigorous comparisons. The challenges of doing so for deep RL experiments have been highlighted recently by Henderson et al. (Deep Reinforcement Learning that Matters, in Thirty-Second AAAI Conference on Artificial Intelligence, 2018) and Colas et al. (How Many Random Seeds? Statistical Power Analysis in Deep Reinforcement Learning Experiments, arXiv preprint arXiv:1806.08295, 2018). We follow their recommendations by using separate seeds for training and evaluation and 20 independent experiment runs for all final comparisons. We also used a hyperparameter search to tune each algorithm on each environment. Agents were trained for 10 M environmental steps for LunarLander-v2/TakeCover-v0 and evaluated using 100 episodes at 50 K step intervals. For the less stochastic Swimmer-v2 and InvertedDoublePendulum-v2, training used 5 M steps and evaluation used 50 episodes to reduce the computational burden. The supplementary material section, below, includes further details of environments, architectures, hyperparameter tuning and the benchmarking setup.

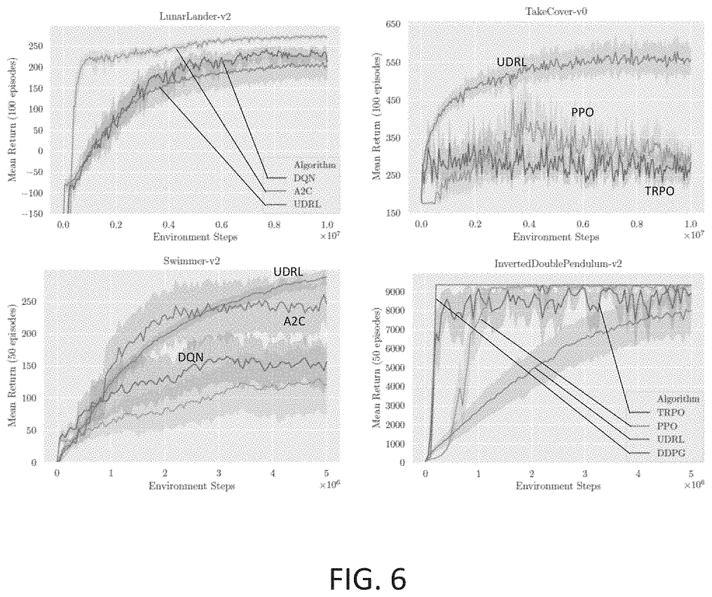

FIG. 6 shows the results on tasks with discrete-valued actions (top row) and continuous-valued actions (bottom row). Solid lines represent the mean of evaluation scores over 20 runs using tuned hyperparameters and experiment seeds 1-20. Shaded regions represent 95% confidence intervals using 1000 bootstrap samples. UDRL is competitive with or outperforms traditional baseline algorithms on all tasks except InvertedDoublePendulum-v2.

3.1 Results

The final 20 runs are plotted in aggregate in FIG. 6, with dark lines showing the mean evaluation return and shaded regions indicating 95% confidence intervals with 1000 bootstrap samples. On LunarLander-v2, all algorithms successfully solved the task (reaching average returns over 200). UDRL performed similar to DQN but both algorithms were behind A2C in sample complexity and final returns, which benefits from its use of multi-step returns. On TakeCover-v0, UDRL outperformed both A2C and DQN comfortably. Inspection of the individual evaluation curves (provided in the supplementary materials section below) showed that both baselines had highly fluctuating evaluations, sometimes reaching high scores but immediately dropping in performance at the next evaluation. While it may be possible to address these instabilities by incorporating additional techniques or modifications to the environment, it is notable that our simple implementation of UDRL does not suffer from them.

On the Swimmer-v2 benchmark, UDRL outperformed TRPO and PPO, and was on par with DDPG. However, DDPG's evaluation scores were highly erratic (indicated by large confidence intervals), and it was rather sensitive to hyperparameter choices. It also stalled completely at low returns for a few random seeds, while UDRL showed consistent progress. Finally, on InvertedDoublePendulum-v2, UDRL was much slower in reaching the maximum return compared to other algorithms, which typically solved the task within 1 M steps. While most runs did reach the maximum return (approx. 9300), some failed to solve the task within the step limit and one run stalled at the beginning of training.

Overall, the results show that while certain implementations of UDRL may lag behind traditional RL algorithms on some tasks, it can also outperform them on other tasks, despite its simplicity and relative immaturity. The next section shows that it can be even more effective when the reward function is particularly challenging.

3.2 Sparse Delayed Reward Experiments

Additional experiments were conducted to examine how UDRL is affected as the reward function characteristics change dramatically. Since UDRL does not use temporal differences for learning, it is reasonable to hypothesize that its behavior may change differently from other algorithms that do. To test this, we converted environments to their sparse, delayed reward (and thus partially observable) versions by delaying all rewards until the last step of each episode. The reward at all other time steps was zero. A new hyperparameter search was performed for each algorithm on LunarLanderSparse-v2; for other environments we reused the best hyperparameters from the dense setting.

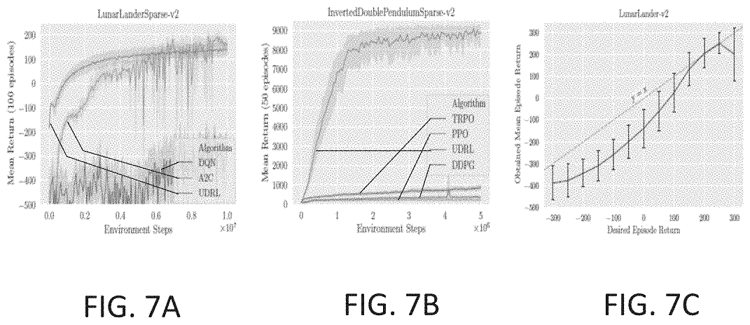

Results for the final 20 runs are plotted in FIGS. 7A-C (Left, Middle, Right). In FIG. 7, Left and Middle: Results on sparse delayed reward versions of benchmark tasks, with semantics same as FIG. 6. A2C with 20-step returns was the only baseline to reach reasonable performance on LunarLanderSparse-v2 (see main text). SwimmerSparse-v2 results are included in the supplementary material section. Right: Desired vs. obtained returns from a trained UDRL agent, showing ability to adjust behavior in response to commands.

The baseline algorithms become unstable, very slow or fail completely as expected. Simple fixes did not work; we failed to train an LSTM DQN on LunarLanderSparse-v2 (which worked as well as A2C for dense rewards), and A2C with 50 or 100-step returns. Unlike UDRL, the best performing baseline on this task (A2C with 20-step returns shown in plot) was very sensitive to hyperparameter settings. It may certainly be possible to solve these tasks by switching to other techniques of standard RL (e.g. Monte Carlo returns, at the price of very high variance). Our aim with this information is simply to highlight that UDRL retained much of its performance in this challenging setting without modification because by design, it directly assigns credit across long time horizons. On one task (Inverted Double Pendulum) its performance improved, even approaching the performance of PPO with dense rewards.

3.3 Different Returns with a Single Agent

The UDRL objective simply trains an agent to follow commands compatible with all of its experience, but the learning algorithm in our experiments adds a couple of techniques to focus on higher returns during training in order to make it somewhat comparable to algorithms that focus only on maximizing returns. This raises the question: do the agents really pay attention to the desired return, or do they simply learn a single policy corresponding to the highest known return? To answer this, we evaluated agents at the end of training by setting various values of d₀^{r} and plotting the obtained mean episode return over 100 episodes. FIG. 3 (right) shows the result of this experiment on a LunarLander-v2 agent. It shows a strong correlation (R≈0.98) between obtained and desired returns, even though most of the later stages of training used episodes with returns close to the maximum. This shows that the agent ‘remembered’ how to act to achieve lower desired returns from earlier in training. We note that occasionally this behavior was affected by stochasticity in training, and some agents did not produce very low returns when commanded to do so. Additional sensitivity plots for multiple agents and environments are provided in the supplementary material.

### Part III: Supplemental Materials Section

Unless otherwise indicated, this section relates to and supplements disclosures in other portions of this application. It primarily includes details related to the experiments in Part II.

Table 1 (below) summarizes some key properties of the environments used in our experiments.

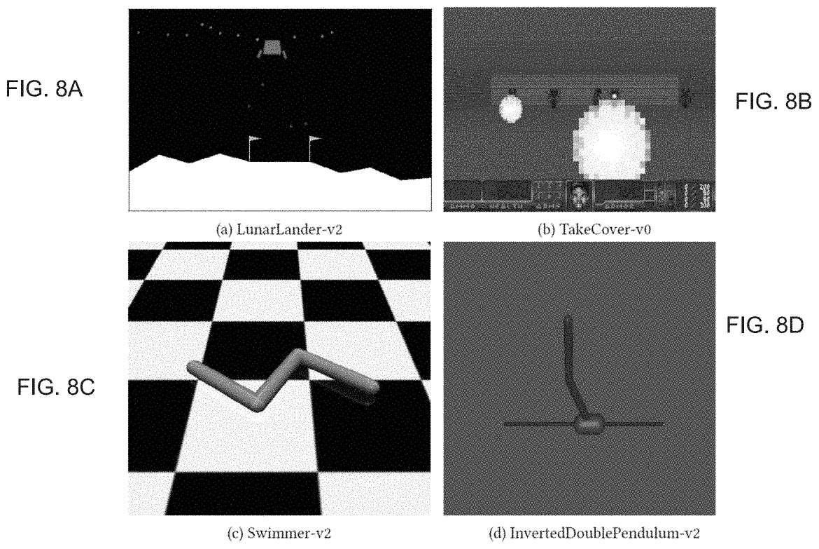

LunarLander-v2 (FIG. 8a) is a simple Markovian environment available in the Gym RL library [Brockman et al., 2016] where the objective is to land a spacecraft on a landing pad by controlling its main and side engines. During the episode the agent receives negative reward at each time step that decreases in magnitude the closer it gets to the optimal landing position in terms of both location and orientation. The reward at the end of the episode is −100 for crashing and +100 for successful landing. The agent receives eight-dimensional observations and can take one out of four actions.

TakeCover-v0 (FIG. 8b) environment is part of the VizDoom library for visual RL research [Kempka et al., 2016]. The agent is spawned next to the center of a wall in a rectangular room, facing the opposite wall where monsters randomly appear and shoot fireballs at the agent. It must learn to avoid fireballs by moving left or right to survive as long as possible. The reward is +1 for every time step that the agent survives, so for UDRL agents we always set the desired horizon to be the same as the desired reward, and convert any fractional values to integers. Each episode has a time limit of 2100 steps, so the maximum possible return is 2100. Due to the difficulty of the environment (the number of monsters increases with time) and stochasticity, the task is considered solved if the average return over 100 episodes exceeds 750. Technically, the agent has a non-Markovian interface to the environment, since it cannot see the entire opposite wall at all times. To reduce the degree of partial observability, the eight most recent visual frames are stacked together to produce the agent observations. The frames are also converted to gray-scale and down-sampled from an original resolution of 160×120 to 64×64.

Swimmer-v2 (FIG. 8C) and InvertedDoublePendulum-v2 (FIG. 8D) are environments available in Gym based on the Mujoco engine[Todorov et al., 2012]. In Swimmer-v2, the task is to learn a controller for a three-link robot immersed in a viscous fluid in order to make it swim as far as possible in a limited time budget of 1000 steps. The agent receives positive rewards for moving forward, and negative rewards proportional to the squared L2 norm of the actions. The task is considered solved at a return of 360. In InvertedDoublePendulum-v2, the task is to balance an inverted two-link pendulum by applying forces on a cart that carries it. The reward is +10 for each time step that the pendulum does not fall, with a penalty of negative rewards proportional to deviation in position and velocity from zero (see source code of Gym for more details). The time limit for each episode is 1000 steps and the return threshold for solving the task is 9100.

TABLE 1
Dimensionality of observations and actions for
environments used in experiments.

| Name | Observations | Actions |
|---|---|---|
| LonarLander-v2 | 8 | 4 (Discrete) |
| TakeCover-v0 | 8 × 64 × 64 | 2 (Discrete) |
| Swimmer-v2 | 8 | 2 (Continuous) |
| InvertedDoublePendulum-v2 | 11 | 1 (Continuous) |

### Network Architectures

In some implementations, UDRL agents strongly benefit from the use of fast weights—where outputs of some units are weights (or weight changes) of other connections. We found that traditional neural architectures can yield good performance, but they can sometimes led to high variation in results across a larger number of random seeds, consequently requiring more extensive hyperparameter tuning. Therefore, in some instances, fast weight architectures are better for UDRL under a limited tuning budget. Intuitively, these architectures provide a stronger bias towards contextual processing and decision making. In a traditional network design where observations are concatenated together and then transformed non-linearly, the network can easily learn to ignore command inputs (assign them very low weights) and still achieve lower values of the loss, especially early in training when the experience is less diverse. Even if the network does not ignore the commands for contextual processing, the interaction between command and other internal representations is additive.

Fast weights make it harder to ignore command inputs during training, and even simple variants enable multiplicative interactions between representations. Such interactions are more natural for representing behavior functions where for the same observations, the agent's behavior should be different depending on the command inputs.
We found a variety of fast weight architectures to be effective during exploratory experiments. For extensive experiments, we considered two of the simplest options: gated and bilinear described below. Considering observation o∈ [symbol] ^{o×1}, command c∈ [symbol] ^{c×1}, and computed contextual representation y∈ [symbol] ^{y×1}, the fast-weight transformations are:

### Gated

g=σ(Uc+p),

x=ƒ(Vo+q),

y=x·g.
Here ƒ is a non-linear activation function, σ is the sigmoid nonlinearity (σ(x)=(1+e^{-x})⁻¹), U∈ [symbol] ^{y×c} and V∈ [symbol] ^{y×o} are weight matrices, p∈ [symbol] ^{y×1} and q∈ [symbol] ^{y×1} are biases.

### Bilinear

W^{l}=Uc+p,

b=Vc+q,

y=ƒ(Wo+b)
Here U∈ [symbol] ^{(y*o)×c}, V∈ [symbol] ^{y×c}, p∈ [symbol] ^{(y*o)×1}, q∈ [symbol] ^{y=1} and W is obtained by reshaping W^{l} from (y*o)×1 to y×o. Effectively a linear transform is applied to o where the transformation parameters are themselves produced through linear transformations of c. This is same as the implementation used by Jayakumar et al. [2020].
   Jayakumar et al. [2020] use multiplicative interactions in the last layer of their networks; we use them in the first layer instead (other layers are fully connected) and thus employ an activation function ƒ (typically y=max(x, 0)). The exceptions are experiments where a convolutional network is used (on TakeCover-v0), where we used a bilinear transformation in the last layer only and did not tune the gated variant.

### UDRL Hyperparameters

Table 2 summarizes hyperparameters for UDRL.

TABLE 2
A summary of UDRL hyperparameters

| Name | Description |
|---|---|
| batch . . . size | Number of (input, target) pairs per batch used |
| | for training the behavior function |
| fast . . . net . . . | Type of fast weight architecture |
| option | (gated or bilinear) |
| horizon . . . scale | Scaling factor for desired horizon input |
| last . . . few | Number of episodes from the end of the replay |
| | buffer used for sampling exploratory commands |
| learning . . . rate | Learning rate for the ADAM optimizer |
| n . . . episodes . . . | Number of exploratory episodes generated per |
| per . . . iter | step of UDRL training |
| n . . . updates . . . | Number of gradient-based updates of the |
| per . . . iter | behavior function per step of UDRL training |
| n . . . warm . . . | Number of warm up episodes at the beginning |
| up . . . episodes | of training |
| replay . . . size | Maximum size of the replay buffer (in episodes) |
| return . . . scale | Scaling factor for desired horizon input |

### Benchmarking Setup and Hyperparameter Tuning

Random seeds for resetting the environments were sampled from [1 M, 10 M) for training, [0.5 M, 1 M) for evaluation during hyperparameter tuning, and [1, 0.5 M) for final evaluation with the best hyperparameters. For each environment, random sampling was first used to find good hyperparameters (including network architectures sampled from a fixed set) for each algorithm based on final performance. With this configuration, final experiments were executed with 20 seeds (from 1 to 20) for each environment and algorithm. We found that comparisons based on few final seeds were often inaccurate or misleading.

Hyperparameters for all algorithms were tuned by randomly sampling settings from a pre-defined grid of values and evaluating each sampled setting with 2 or 3 different seeds. Agents were evaluated at intervals of 50 K steps of interaction, and the best hyperparameter configuration was selected based on the mean of evaluation scores for last 20 evaluations during each experiment, yielding the configurations with the best average performance towards the end of training.

256 configurations were sampled for LunarLander-v2 and LunarLanderSparse-v2, 72 for TakeCover-v0, and 144 for Swimmer-v2 and InvertedDoublePendulum-v2. Each random configuration of hyperparameters was evaluated with 3 random seeds for LunarLander-v2 and LunarLanderSparse-v2, and 2 seeds for other environments.

Certain hyperparameters that can have an impact on performance and stability in RL were not tuned. For example, the hyperparameters of the Adam optimizer (except the learning rate) were kept fixed at their default values. All biases for UDRL networks were zero at initialization, and all weights were initialized using orthogonal initialization. No form of regularization (including weight decay) was used for UDRL agents; in principle we expect regularization to improve performance.

We note that the number of hyperparameter samples evaluated is very small compared to the total grid size. Thus, our experimental setup is a proxy for moderate hyperparameter tuning effort in order to support reasonably fair comparisons, but it is likely that it does not discover the maximum performance possible for each algorithm.

### Grids for Random Hyperparameter Search

In the following subsections, we define the lists of possible values for each of the hyperparameters that were tuned for each environment and algorithm. For traditional algorithms such as DQN etc., any other hyperparameters were left at their default values in the Stable-Baselines library. The DQN implementation used “Double” Q-learning by default, but additional tricks for DQN that were not present in the original papers were disabled, such as prioritized experience replay. Here numpy refers to the Python library available from https://numpy.org/.

### LunarLander-v2 & LunarLanderSparse-v2

### Network Architecture

Network architecture (indicating number of units per layer): [[32], [32, 32], [32, 64], [32, 64, 64], [32, 64, 64, 64], [64], [64, 64], [64, 128], [64, 128, 128], [64, 128, 128, 128]]

### DQN Hyperparameters

Activation function: [tan, relu]
Batch Size: [16, 32, 64, 128]
Buffer Size: [10 000, 50 000, 100 000, 500 000, 1000 000]
Discount factor: [0.98, 0.99, 0.995, 0.999]
Exploration Fraction: [0.1, 0.2, 0.4]
Exploration Final Eps: [0.0, 0.01, 0.05, 0.1]
Learning rate: numpy.logspace(−4, −2, num=101)
Training Frequency: [1, 2, 4]
Target network update frequency: [100, 500, 1000]

### A2C Hyperparameters

Activation function: [tan, relu]
Discount factor: [0.98, 0.99, 0.995, 0.999]
Entropy coefficient: [0, 0.01, 0.02, 0.05, 0.1]
Learning rate: numpy.logspace(−4, −2, num=101)
Value function loss coefficient: [0.1, 0.2, 0.5, 1.0]
Decay parameter for RMSProp: [0.98, 0.99, 0.995]
Number of steps per update: [1, 2, 5, 10, 20]

### UDRL Hyperparameters

batch_size: [512, 768, 1024, 1536, 2048]
Fast net option: [‘bilinear’, ‘gated’]
horizon_scale: [0.01, 0.015, 0.02, 0.025, 0.03]
last_few: [25, 50, 75, 100]
learning_rate: numpy. logspace(−4, −2, num=101)
n_episodes_per_iter: [10, 20, 30, 40]
n_updates_per_iter: [100, 150, 200, 250, 300]
n_warm_up_episodes: [10, 30, 50]
replay_size: [300, 400, 500, 600, 700]
return_scale: [0.01, 0.015, 0.02, 0.025, 0.03]

### TakeCover-v0

Network Architecture All networks had four convolutional layers, each with 3 3 filters, 1-pixel input padding in all directions and stride of 2 pixels.

The architecture of convolutional layers (indicating number of convolutional channels per layer) was sampled from [[32, 48, 96, 128], [32, 64, 128, 256], [48, 96, 192, 384]].

The architecture of fully connected layers following the convolutional layers was sampled from[[64, 128], [64, 128, 128], [128, 256], [128, 256, 256], [128, 128], [256, 256]].

### Hyperpameters

Hyperparameter choices for DQN and A2C were the same as those for LunarLander-v2. For UDRL the following choices were different:
n_updates_per_iter: [200, 300, 400, 500]
replay_size: [200, 300, 400, 500]
return_scale: [0.1, 0.15, 0.2, 0.25, 0.3]

### Swimmer-v2 and InvertedDoublePendulum-v2

### Network Architecture

Network architecture (indicating number of units per layer): [[128], [128, 256], [256, 256], [64, 128, 128, 128], [128, 256, 256, 256]]

### TRPO Hyperparameters

Activation function: [tan, relu]
Discount factor: [0.98, 0.99, 0.995, 0.999]
Time steps per batch: [256, 512, 1024, 2048]
Max KL loss threshold: [0.005, 0.01, 0.02]
Number of CG iterations: [5, 10, 20]
GAE factor: [0.95, 0.98, 0.99]
Entropy Coefficient: [0.0, 0.1, 0.2]
Value function training iterations: [1, 3, 5]

### PPO Hyperparameters

Activation function: [tan, relu]
Discount factor: [0.98, 0.99, 0.995, 0.999]
Learning rate: numpy.logspace(−4, −2, num=101)
Number of environment steps per update: [64, 128, 256]
Entropy coefficient for loss: [0.005, 0.01, 0.02]
Value function coefficient for loss: [1.0, 0.5, 0.1]
GAE factor: [0.9, 0.95, 0.99]
Number of minibatches per update: [2, 4, 8]
Number of optimization epochs: [2, 4, 8]
PPO Clipping parameter: [0.1, 0.2, 0.4]

### DDPG Hyperparameters

Activation function: [tan, relu]
Discount factor: [0.98, 0.99, 0.995, 0.999]
Sigma for OU noise: [0.1, 0.5, 1.0]
Observation normalization: [False, True]
Soft update coefficient: [0.001, 0.002, 0.005]
Batch Size: [128, 256]
Return normalization: [False, True]
Actor learning rate: numpy. logspace(−4, −2, num=101)
Critic learning rate: numpy. logspace(−4, −2, num=101)
Reward scale: [0.1, 1, 10]
Buffer size: [50 000, 100000]
Probability of random exploration: [0.0, 0.1]

### UDRL Hyperparameters

batch_size: [256, 512, 1024]
fast_net_option: [‘bilinear’, ‘gated’]
horizon_scale: [0.01, 0.02, 0.03, 0.05, 0.08]
last_few: [1, 5, 10, 20]
learning_rate: [0.0001, 0.0002, 0.0004, 0.0006, 0.0008, 0.001]
n_episodes_per_iter: [5, 10, 20]
n_updates_per_iter: [250, 500, 750, 1000]
n_warm_up_episodes: [10, 30, 50]
replay_size: [50, 100, 200, 300, 500]
return_scale: [0.01, 0.02, 0.05, 0.1, 0.2]

### Additional Plots

### SwimmerSparse-v2 Results

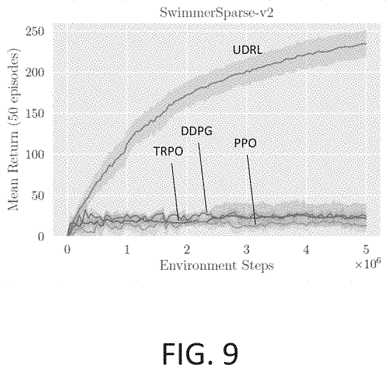

FIG. 9 presents the results on SwimmerSparse-v2, the sparse delayed reward version of the Swimmer-v2 environment. Similar to other environments, the key observation is that UDRL retained much of its performance without modification. The hyperparameters used were same as the dense reward environment.

### Sensitivity to Initial Commands

This section includes additional evaluations of the sensitivity of UDRL agents at the end of training to a series of initial commands(see Section 3.4 in the main section above).

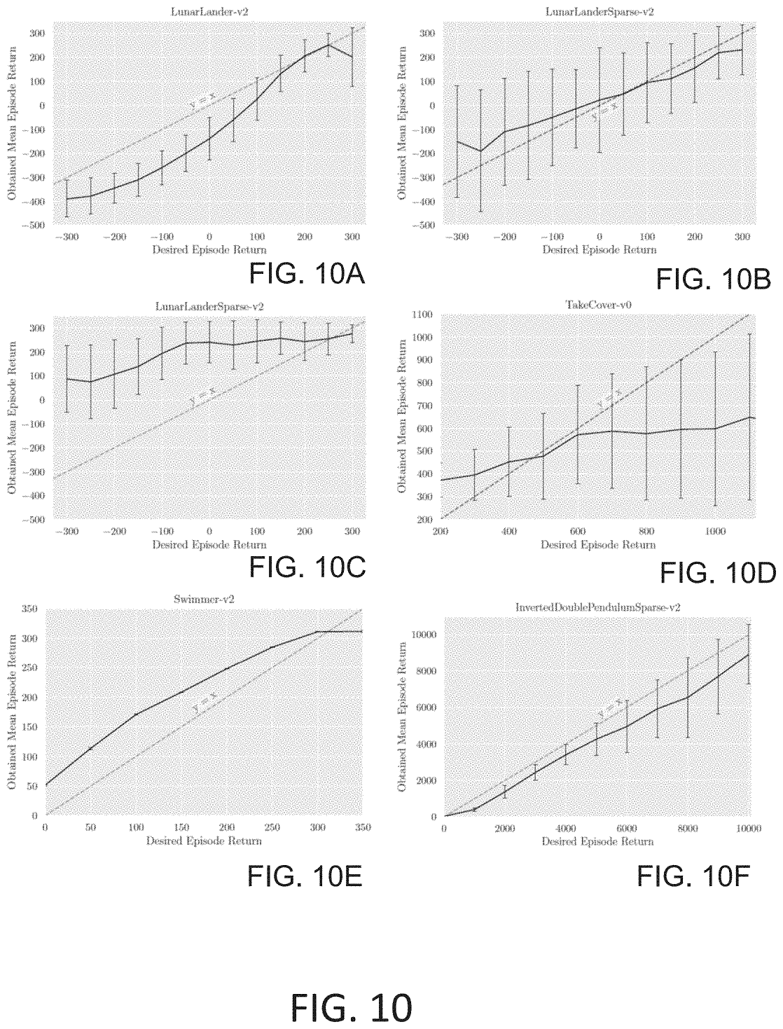

FIGS. 10a-10f show obtained vs. desired episode returns for UDRL agents at the end of training. Each evaluation consists of 100 episodes. Error bars indicate standard deviation from the mean. Note the contrast between (a) and (c): both are agents trained on LunarLanderSparse-v2. The two agents differ only in the random seed used for the training procedure, showing that variability in training can lead to different sensitivities at the end of training. FIGS. 10a, 10b, 10e and 10f show a strong correlation between obtained and desired returns for randomly selected agents on LunarLander-v2 and LunarLanderSparse-v2. Notably, FIG. 10c shows another agent trained on LunarLanderSparse-v2 that obtains a return higher than 200 for most values of desired returns, and only achieves lower returns when the desired return is very low. This indicates that stochasticity during training can affect how trained agents generalize to different commands and suggests another direction for future investigation.

A possible complication in this evaluation is that it is unclear how to set the value of the initial desired horizon d₀^{h} for various values of d₀^{r}. This is easier in some environments: in TakeCover-0, we set d₀^{h} equal to d₀^{r}. Similarly, for InvertedDoublePendulumSparse-v2 where the agent gets a reward of +10 per step, we set d₀^{h}=d₀^{r}/10. This does not take the position and velocity penalties into account, but is sufficiently reasonable. For other environments, we simply use the d₀^{h} value at the end of training for all desired returns. In general the agent's lifelong experience can be used to keep track of realistic values of d₀^{h} and d₀^{r}, which may be dependent on the initial state.

In the TakeCover-v0 environment, it is rather difficult to achieve precise values of desired returns. Stochasticity in the environment (the monsters appear randomly and shoot in random directions) and increasing difficulty over the episode imply that it is not possible to achieve lower returns than 200 and it becomes progressively harder to achieve higher mean returns. The results in FIG. 10d reflect these constraints. Instead of increased values of mean returns, we observe higher standard deviation for higher values of desired return.

### Software & Hardware

Our setup directly relied upon the following open source software:
Gym 0.15.4 [Brockman et al., 2016]
Matplotlib [Hunter, 2007]
Numpy 1.18.1 [Walt et al., 2011, Oliphant, 2015]
OpenCV [Bradski, 2000]
Pytorch 1.4.0 [Paszke et al., 2017]
Ray Tune 0.6.6 [Liaw et al., 2018]
Sacred 0.7.4 [Greff et al., 2017]
Seabom[Waskom et al., 2018]
Stable-Baselines 2.9.0 [Hill et al., 2018]
Vizdoom 1.1.6 [Kempka et al., 2016]
Vizdoomgym [Hakenes, 2018]

For LunarLander and TakeCover experiments, gym==0.11.0, stable-baselines==2.5.0, pytorch==1.1.0 were used. Mujoco 1.5 was used for continuous control tasks.

Almost all experiments were run on cloud computing instances with Intel Xeon processors. Nvidia P100 GPUs were used for TakeCover experiments. Each experiment occupied one or two vCPUs, and 33% GPU capacity (if used). Some TakeCover experiments were run on local hardware with Nvidia V100 GPUs.

A number of embodiments of the invention have been described. Nevertheless, it will be understood that various modifications may be made without departing from the spirit and scope of the invention.

For example, the components in the computer system of FIG. 1 can be local to one another (e.g., in or connected to one common device) or distributed across multiple locations and/or multiple discrete devices. Moreover, each component in the computer system of FIG. 1 may represent a collection of such components contained in or connected to one common device or distributed across multiple locations and/or multiple discrete devices. Thus, the processor may be one processor or multiple processors in one common device or distributed across multiple locations and/or in multiple discrete devices. Similarly, the memory may be one memory device or memory distributed across multiple locations and/or multiple discrete devices.

The communication interface to the external environment in the computer system may have address, control, and/or data connections to enable appropriate communications among the illustrated components.

Any processor is a hardware device for executing software, particularly that stored in the memory. The processor can be, for example, a custom made or commercially available single core or multi-core processor, a central processing unit (CPU), an auxiliary processor among several processors associated with the present computer system, a semiconductor based microprocessor (e.g., in the form of a microchip or chip set), a macro-processor, or generally any device for executing software instructions. In some implementations, the processor may be implemented in the cloud, such that associated processing functionalities reside in a cloud-based service which may be accessed over the Internet.

Any computer-based memory can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory may incorporate electronic, magnetic, optical, and/or other types of storage media. The memory can have a distributed architecture, with various memory components being situated remotely from one another, but accessible by the processor.

The software may include one or more computer programs, each of which contains an ordered listing of executable instructions for implementing logical functions associated with the computer system, as described herein. The memory may contain the operating system (O/S) that controls the execution of one or more programs within the computer system, including scheduling, input-output control, file and data management, memory management, communication control and related services and functionality.

The I/O devices may include one or more of any type of input or output device. Examples include a keyboard, mouse, scanner, microphone, printer, display, etc. Moreover, in a typical implementation, the I/O devices may include a hardware interface to the environment that the computer interacts with. The hardware interface may include communication channels (wired or wireless) and physical interfaces to computer and/or the environment that computer interacts with. For example, if the environment that the computer interacts with is a video game, then the interface may be a device configured to plug into an interface port on the video game console. In some implementations, a person having administrative privileges over the computer may access the computer-based processing device to perform administrative functions through one or more of the I/O devices. Moreover, the hardware interface may include or utilize a network interface that facilitates communication with one or more external components via a communications network. The network interface can be virtually any kind of computer-based interface device. In some instances, for example, the network interface may include one or more modulator/demodulators (i.e., modems) for accessing another device, system, or network, a radio frequency (RF) or other transceiver, a telephonic interface, a bridge, router, or other device. During system operation, the computer system may receive data and send notifications and other data via such a network interface.

A feedback sensor in the environment outside of the computer system can be any one of a variety of sensors implemented in hardware, software or a combination of hardware and software. For example, in various implementations, the feedback sensors may include, but are not limited to, voltage or current sensors, vibration sensors, proximity sensors, light sensors, sound sensors, screen grab technologies, etc. Each feedback sensor, in a typical implementation, would be connected, either directly or indirectly, and by wired or wireless connections, to the computer system and configured to provide data, in the form of feedback signals, to the computer system on a constant, periodic, or occasional basis. The data represents and is understood by the computer system as an indication of a corresponding characteristic of the external environment that may change over time.

In various implementations, the computer system may have additional elements, such as controllers, other buffers (caches), drivers, repeaters, and receivers, to facilitate communications and other functionalities.

Various aspects of the subject matter disclosed herein can be implemented in digital electronic circuitry, or in computer-based software, firmware, or hardware, including the structures disclosed in this specification and/or their structural equivalents, and/or in combinations thereof. In some embodiments, the subject matter disclosed herein can be implemented in one or more computer programs, that is, one or more modules of computer program instructions, encoded on computer storage medium for execution by, or to control the operation of, one or more data processing apparatuses (e.g., processors). Alternatively, or additionally, the program instructions can be encoded on an artificially generated propagated signal, for example, a machine-generated electrical, optical, or electromagnetic signal that is generated to encode information for transmission to suitable receiver apparatus for execution by a data processing apparatus. A computer storage medium can be, or can be included within, a computer-readable storage device, a computer-readable storage substrate, a random or serial access memory array or device, or a combination thereof. While a computer storage medium should not be considered to be solely a propagated signal, a computer storage medium may be a source or destination of computer program instructions encoded in an artificially generated propagated signal. The computer storage medium can also be, or be included in, one or more separate physical components or media, for example, multiple CDs, computer disks, and/or other storage devices.

Certain operations described in this specification can be implemented as operations performed by a data processing apparatus (e.g., a processor/specially-programmed processor) on data stored on one or more computer-readable storage devices or received from other sources. The term “processor” (or the like) encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be described herein as occurring in a particular order or manner, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In various implementations, the memory and buffers are computer-readable storage media that may include instructions that, when executed by a computer-based processor, cause that processor to perform or facilitate one or more (or all) of the processing and/or other functionalities disclosed herein. The phrase computer-readable medium or computer-readable storage medium is intended to include at least all mediums that are eligible for patent protection, including, for example, non-transitory storage, and, in some instances, to specifically exclude all mediums that are non-statutory in nature to the extent that the exclusion is necessary for a claim that includes the computer-readable (storage) medium to be valid. Some or all of these computer-readable storage media can be non-transitory.

Other implementations are within the scope of the claims.

What is claimed is:

1. A method comprising:
initializing a set of parameters for a computer-based learning model;
providing a command input into the computer-based learning model as part of a trial, wherein the command input calls for producing a specified reward within a specified amount of time in an environment external to the computer-based learning model;
producing an output with the computer-based learning model based on the command input; and
utilizing the output to cause an action in the environment external to the computer-based learning model.

2. The method of claim 1, further comprising:
receiving feedback data from one or more feedback sensors in the external environment after the action.

3. The method of claim 2, wherein the feedback data comprises data that represents an actual reward produced in the external environment by the action.

4. The method of claim 3, wherein the output produced by the computer-based learning model depends on the set of parameters for the computer-based learning model.

5. The method of claim 4, further comprising storing a copy of the set of parameters in computer-based memory.

6. The method of claim 5, further comprising:
adjusting the set of parameters in the copy to produce an adjusted set of parameters.

7. The method of claim 6, wherein the set of parameters in the copy are adjusted using supervised learning based on actual prior command inputs to the computer-based learning model and actual resulting feedback data.

8. The method of claim 7, further comprising:
periodically replacing the set parameters used by the computer-based learning model to produce outputs with the adjusted set of parameters.

9. The method of claim 8, further comprising:
initializing a value in timer for the trial prior to producing the output to cause the action in the external environment; and
incrementing the value in the timer to a current value if the trial is not complete after causing the action in the external environment.

10. The method of claim 9, further comprising updating a time associated with adjusting the set of parameters in the copy to match the current value.

11. The method of claim 1, wherein the computer-based learning model is an artificial neural network.

12. The method of claim 1, wherein the specified reward in the specified amount of time indicated in the command input represent something other than simply an optimization of reward and time.

13. The method of claim 1, wherein the command input represents something other than a simple desire to produce a specific total reward in a specific amount of time.

14. The method of claim 1, further comprising producing the command input to match an already observed event.

15. The method of claim 14, wherein the already observed event already produced the specified reward in the specified amount of time.

16. A method of training a computer-based learning model, the method comprising:
producing a command input for a computer-based learning model, wherein the command input calls for an event that matches an event that the computer-based learning model already has observed;
providing the command input into the computer-based learning model; and
producing an output with the computer-based learning model based on the command input.

17. The method of claim 16, wherein the command input calls for producing a specified reward within a specified amount of time in an environment external to the computer-based learning model, and wherein the already observed event produced the specified reward in the specified amount of time.

18. The method of claim 16, further comprising:
mapping the command input to an action that matches an observed action from the observed event through supervised learning.

19. The method of claim 16, further comprising utilizing the output to cause an action in the environment external to the computer-based learning model.
